(19) United States
(12) Patent Application Publication
(10) Pub. No.: US 2007/0101262 A1
(43) Pub. Date: May 3, 2007

(54) Data transformation from content data for viewing content in network environment into data for printing the same on consecutive pages

(75) Inventors: Masashi Suzuki, Nagoya (JP); Kazuma Aoki, Kasugai (JP); Satoshi Watanabe, Kasugai (JP); Kiyotaka Ohara, Nagoya (JP); Makoto Matsuda, North Brunswick, NJ (US)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 11/589,844

(22) Filed: Oct. 31, 2006

(30) Foreign Application Priority Data
Oct. 31, 2005 (JP) 2005-317056

(51) Int. Cl. G06F 17/00; G06F 3/12

(52) U.S. Cl. 715/525; 358/1.15; 715/526

(57) ABSTRACT

An information terminal equipment communicable with a server via a network is disclosed. The equipment includes: a unit that enables the equipment to communicate with the server; and a selector that selects as a first content one of content elements represented by displaying data received from the server, based on the displaying data. The first content element is to be displayed on a display screen at a pre-selected display location. The equipment further includes: a transformer operable when a second printed image corresponding to a second content one of the content elements is to be printed over a plurality of consecutive pages, to transform the received displaying data into printed-image data for allowing a first printed image corresponding to the first content element to be printed on separate print-sheets redundantly over a sub-plurality of pages equal or the plurality of pages, at a pre-selected print location on each page.

### CROSS-REFERENCE TO RELATED APPLICATIONS

This application is based on Japanese Patent Application No. 2005-317056 filed Oct. 31, 2005, the content of which is incorporated hereinto by reference.

### BACKGROUND OF THE INVENTION

1. Field of the Invention

The invention relates to techniques of data transformation from content data for viewing content in a network environment into data for printing the same on consecutive pages.

2. Description of the Related Art

As conventional server-devices storing viewable content objects, there are known web servers which are configured to store web pages representative of various kinds of content objects.

In the art, the term “content object” is used in a sense to include content (data appearing between the starting and ending tags in a tagged language document (e.g., an HTML document), digital content, web content, media content, a composition of content elements (e.g., blocks of texts, blocks of images, blocks of texts and images, etc.), the content of an electronic document, viewable information, a visual representation, etc.

Further, the term “web pages” is used in a sense to include documents or other resources on the World Wide Web. Each web page is identified by a unique Uniform Resource Locator (URL), which is a global address of the document or other resource.

As conventional information-terminal-equipments, there are known personal computers which are configured to obtain a web page from a web server using an application program called “browser” or “web browser” and to display the web page on a display screen of a monitor (e.g., a video monitor); printing devices which are configured to obtain a web page from a web server and to print the web page; etc.

Typically, the information terminal equipments are in the form of, for example, networked computers (e.g., wireless-networked, wire-networked, wide-area-networked, or local-area-networked computers, etc.), web-based computers, personal computers (e.g., desktop, laptop, or palmtop computers, etc.), cellular phones, PDAs (personal digital assistants), etc. This definition applies throughout this written description.

Furthermore, as conventional hybrid systems incorporating web servers, personal computers and printing devices, there are known systems which are configured to cause a web server to output a requested content object to a recipient device selectively in the form of displaying data or a web page or in the form of printing data, in accordance with the type of the recipient device. An example of such systems is disclosed in Japanese Patent Application Publication No. 2001-101303.

Web pages, because of their expected uses of being typically displayed on display screens of monitors, are each created to have a layout configuration reflecting the expected uses.

### BRIEF SUMMARY OF THE INVENTION

In general, the present invention relates to transformation of content data for viewing content in a network environment into data for printing the content on consecutive pages.

In some aspects, the present invention provides an information terminal equipment allowing a specified set of information to easily catch a user's eye when a content object (e.g., a web page) containing the specified set of information is printed out over a plurality of consecutive separate pages, using content data for viewing the content object on a display screen.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a schematic diagram illustrating a data presentation system 1 constructed according to a first embodiment of the present invention;

FIG. 2 is a flow chart conceptually illustrating web server processing performed by web servers 10 and 20 depicted in FIG. 1;

FIG. 3 is a flow chart conceptually illustrating browser processing performed by a CPU 31a of a PC 30 depicted in FIG. 1;

FIG. 4 is a flow chart conceptually illustrating web-page printing processing performed by the CPU 31a depicted in FIG. 1;

FIG. 5 is an illustrative view of the first half of the source code for an exemplary web page including printing data;

FIG. 6 is an illustrative view of the second half of the source code of the exemplary web page of FIG. 5 including the printing data;

FIG. 7 is a flow chart conceptually illustrating of first transformation processing performed by the CPU 31a depicted in FIG. 1;

FIG. 8 is an illustrative view of a print page or a sheet of paper partitioned into sections, for explaining the distribution of those sections;

FIG. 9 is an illustrative view of the source code of another exemplary web page;

FIG. 10 is an illustrative view of a display layout and a print layout of the exemplary web page of FIG. 9, for explaining the correspondence between the display layout and the print layout;

FIG. 11 is a flow chart conceptually illustrating of second transformation processing performed by the CPU 31a depicted in FIG. 1;

FIG. 12 is a flow chart conceptually illustrating processing performed in a multi-function peripheral 50 by a CPU 51a of the multi-function peripheral 50 constructed according to a second embodiment of the present invention; and

FIG. 13 is a flow chart conceptually illustrating web print processing performed in the multi-function peripheral 50 by the CPU 51a, which is constructed according to the second embodiment of the present invention.

### DETAILED DESCRIPTION OF THE INVENTION

General Overview

According to a first aspect of the present invention, an information terminal equipment communicable with a server device via a network is provided.

In this regard, the server device is configured such that, in response to reception of a content request signal from the information terminal equipment via the network, the server device sends content data at least including displaying data for use in displaying on a display screen a content object requested by the content request signal.

This information terminal equipment comprises:

a communication unit that enables the information terminal equipment to communicate with the server device via the network;

a content-element selector that selects as a first content element one of a plurality of content elements represented by the displaying data, based on the displaying data received from the server device, wherein the first content element is to be displayed on the display screen at a pre-selected display location on the content object; and

a data transformer operable when a second printed image corresponding to a second content element of the plurality of content elements which is other than the first content element is to be printed over a plurality of consecutive pages, to transform the received displaying data into printed-image data for allowing a first printed image corresponding to the first content element to be printed on separate print-sheets redundantly over a sub-plurality of consecutive pages equal to or fewer than the plurality of consecutive pages on which the second printed image is printed, at a pre-selected print location on each page.

The phrase “display location on the content object” set forth above means, for example, when the content object (e.g., a single web page) is not larger in size than the display screen (i.e., a physical screen), a certain display location on the content object which is entirely displayed on the display screen at a time, and when the content object is larger in size than the display screen, a certain display location on the content object which is partially displayed on the display screen at a time, but in a scrollable manner.

According to a second aspect of the present invention, an information terminal equipment communicable with a server device via a network is provided.

In this regard, the server device is configured such that, in response to reception of a content request signal from the information terminal equipment via the network, the server device sends content data at least including displaying data for use in displaying on a display screen a content object requested by the content request signal.

The content data further includes printing data for use in printing the content object, the printing data indicating whether each of the plurality of content elements is a primary content element or a subsidiary content element.

This information terminal equipment comprises:

a communication unit that enables the information terminal equipment to communicate with the server device via the network; and

a data transformer operable when a primary printed image corresponding to the primary content element is to be printed over a plurality of consecutive pages, to transform the content data received from the server device, into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

According to a third aspect of the present invention, a method is provided of operating an information terminal equipment communicable with a server device via a network.

In this regard, the server device is configured such that, in response to reception of a content request signal from the information terminal equipment via the network, the server device sends content data at least including displaying data for use in displaying on a display screen a content object requested by the content request signal.

This method comprises the steps of:

sending the content request signal to the server device;

receiving the content data from the server device, the content data including the displaying data;

selecting as a first content element one of a plurality of content elements represented by the displaying data, based on the displaying data received from the server device, wherein the first content element is to be displayed on the display screen at a pre-selected display location on the content object; and

when a second printed image corresponding to a second content element of the plurality of content elements which is other than the first content element is to be printed over a plurality of consecutive pages, transforming the received displaying data into printed-image data for allowing a first printed image corresponding to the first content element to be printed on separate print-sheets redundantly over a sub-plurality of consecutive pages equal to or fewer than the plurality of consecutive pages on which the second printed image is printed, at a pre-selected print location on each page.

According to a fourth aspect of the present invention, a method is provided of operating an information terminal equipment communicable with a server device via a network.

In this regard, the server device is configured such that, in response to reception of a content request signal from the information terminal equipment via the network, the server device sends content data at least including displaying data for use in displaying on a display screen a content object requested by the content request signal.

The content data further includes printing data for use in printing the content object, the printing data indicating whether each of the plurality of content elements is a primary content element or a subsidiary content element.

This method comprises the steps:

sending the content requesting signal to the server device;

receiving the content data from the server device, the content data including the displaying data and the printing data; and

when a primary printed image corresponding to the primary content element is to be printed over a plurality of consecutive pages, transforming the received content data into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

Illustrative Embodiments

According to the invention, the following modes are provided as the illustrative embodiments of the invention.

These modes will be stated below so as to be sectioned and numbered, and so as to depend upon the other mode or modes, where appropriate. This is for a better understanding of some of a plurality of technological features and a plurality of combinations thereof disclosed in this description, and does not mean that the scope of these features and combinations is interpreted to be limited to the scope of the following modes of this invention.

That is to say, it should be interpreted that it is allowable to select the technological features which are stated in this description but which are not stated in the following modes, as the technological features of this invention.

Furthermore, stating each one of the modes of the invention in such a dependent form as to depend from the other mode or modes does not exclude the possibility that the technological features set forth in a dependent-form mode become independent of those set forth in the corresponding depended mode or modes and to be removed therefrom. It should be interpreted that the technological features set forth in a dependent-form mode are allowed to become independent, where appropriate.

(1) An information terminal equipment communicable with a server device via a network,

wherein the server device is configured such that, in response to reception of a content request signal from the information terminal equipment via the network, the server device sends content data at least including displaying data for use in displaying on a display screen a content object requested by the content request signal,

the information terminal equipment comprising:

a communication unit that enables the information terminal equipment to communicate with the server device via the network;

a content-element selector that selects as a first content element one of a plurality of content elements represented by the displaying data, based on the displaying data received from the server device, wherein the first content element is to be displayed on the display screen at a pre-selected display location on the content object; and

a data transformer operable when a second printed image corresponding to a second content element of the plurality of content elements which is other than the first content element is to be printed over a plurality of consecutive pages, to transform the received displaying data into printed-image data for allowing a first printed image corresponding to the first content element to be printed on separate print-sheets redundantly over a sub-plurality of consecutive pages equal to or fewer than the plurality of consecutive pages on which the second printed image is printed, at a pre-selected print location on each page.

This information terminal equipment therefore would allow a printed image corresponding to the displaying data to be printed on consecutive separate sheets, in a manner that one of content elements (i.e., sets of information) which has a display location equal to a pre-selected display location (i.e., a specific display location) on a display screen catches a user's eye with enhanced ease.

An example of the pre-selected display location may be an advertising location at which an advertising image is typically laid out on a display screen.

When this information terminal equipment is practiced in an exemplary arrangement in which an image displayed on a display screen at an advertising location is printed redundantly over a plurality of separate sheets, the advertising image, at the time of printing out the whole content presented to a user from the server device via the network, is printed redundantly over a plurality of separate sheets, resulting in enhanced advertising effect of the advertising image.

In this information terminal equipment, the displaying data may be used to define the display layout of a document (i.e., an example of the content) within a display screen. In this instance, the display layout may be standardized for allowing a reference helpful to a user in understanding the document to be displayed at the pre-selected display location on the display screen.

When this information terminal equipment is practiced in an exemplary arrangement in which such a reference displayed at the pre-selected display location is printed redundantly over a plurality of separate sheets, the reference, at the time of printing out the document presented to a user from the server device via the network, is printed redundantly over a plurality of separate sheets.

This arrangement would allow the content represented by the displaying data to be printed on sheets based on the displaying data, in the form of a document readily understandable to a user.

In this information terminal equipment, the printed-image data may be, for example, a type of data used for instructing a printer to print out a requested content on separate sheets.

When practicing this information terminal equipment, although the first printed image, which corresponds to the first content element may be printed over a sub-plurality of pages which are fewer than a plurality of pages over which the second printed image is to be printed, the first printed image is preferably printed over a total of a plurality of pages over which the second printed image is to be printed.

When practicing this information terminal equipment, the first printed image may be printed over a plurality of pages, with the first printed image appearing on every page or on decimated pages, for example.

(2) The information terminal equipment according to mode (1), further comprising:

a content requesting unit that sends the content request signal to the server device;

a data reception unit that receives the content data incoming from the server device; and

a printer controller that causes a printer to print the first printed-image on separate print-sheets over the sub-plurality of consecutive pages, based on the printed-image data produced by the data transformer.

When embodying this information terminal equipment, the printer may be constructed to be physically separate from or integral with the information terminal equipment.

(3) The information terminal equipment according to mode (1) or (2), wherein the displaying data is constructed to include:

the plurality of content elements to be displayed on the display screen; and

information for identifying display locations at which the plurality of content elements are to be respectively displayed on the display screen.

(4) The information terminal equipment according to any one of modes (1)-(3), wherein the data transformer produces the printed-image data, such that a print location at which the first printed image is to be printed is assigned to a first print location which is pre-selected geometrically relative to each page, and such that a print location at which the second printed image is printed is assigned to a second print location which is pre-selected geometrically relative to each page.

(5) The information terminal equipment according to any one of modes (1)-(4), wherein the data transformer produces the printed-image data, such that, provided that the second printed image is to be printed over the plurality of consecutive pages, the first printed image is printed redundantly over a total of the same pages, at the pre-selected print location on each page.

This information terminal equipment would allow the first content element, which is to say, one of content elements (i.e., sets of information) which has a display location equal to a pre-selected display location (i.e., a specific display location) on a display screen, to be printed redundantly over a total of a plurality of pages over which the second content element is printed.

Therefore, this information terminal equipment would allow the first content element having the specific display location to catch a user's eye through a series of the printed pages (i.e., a printed matter) more easily than when the same is printed redundantly over of a part of a plurality of pages over which the second content element is printed.

Additionally, this information terminal equipment, when the first content element contains an advertising image or information, would avoid a user action of throwing away a part of the printed pages, if any, from lessening the advertising effect of the advertising image, because the first content element is printed redundantly over a total of a plurality of pages over which the second content element is printed.

As a result, this information terminal equipment would allow the advertising effect of the advertising image to be enhanced.

(6) The information terminal equipment according to any one of modes (1)-(5), wherein the display location includes a top section on the content object,

wherein the content-element selector selects as the first content element one of the plurality of content elements which is to be displayed at the top section, and

wherein the data transformer produces the printed-image data, such that, provided that the second printed image is to be printed over the plurality of consecutive pages, the first printed image is printed redundantly over the sub-plurality of consecutive pages, at a header section on each print sheet.

In a network environment, a desired content is displayed in the form of a web page on a display screen using displaying data presented from a network (e.g., a wide area network (e.g., the Internet) or a local area network). In a typical web page, there is a highly likelihood that an advertising image is laid out on a web page at its top section.

Therefore, for example, it is preferable to define the displaying data as web page data, to define the pre-selected display location as the top section of the web page, and to define the first printed image as an advertising image.

With this in mind, in this information terminal equipment constructed according to the present mode, one of a plurality of content elements which is to be displayed at a top section on the content object is selected as the first content element.

Further, the printed-image data is produced when the second printed image is to be printed over a plurality of consecutive pages, such that the first printed image is printed redundantly over a sub-plurality of consecutive pages, at a header section on each print sheet.

When practicing this information terminal equipment in an exemplary arrangement in which a web page is displayed on a display screen in a manner that an advertising image is laid out at a top section of the web page, the web page is printed, when needed, such that the advertising image appears redundantly over a plurality of pages over which other elements in the same web page (e.g., a text body) are to be printed.

Additionally, this information terminal equipment would allow the first content element, which is to say, one of content elements which is displayed at a top section of the content object, to be printed on each print page at its header section.

In this regard, the top section on the content object and the header section on each print page are comparable in terms of position.

Therefore, this information terminal equipment would allow the first content element to be printed on pages based on the displaying data representative of the first content element, in a print layout without any major changes from the original display layout of the first content element.

(7) The information terminal equipment according to mode (6), wherein the server device is a web server storing a web page defining the content object,

wherein the displaying data is constructed in a table allowing the plurality of content elements to be represented in association with respective display locations on the web page, to thereby describe the web page,

wherein the table includes information indicating that the first printed image is to be printed at the header section, and

wherein the header section is pre-selected positionally relative to each print sheet designated by a user.

(8) The information terminal equipment according to any one of modes (1)-(7), wherein the display location includes a bottom section on the content object,

wherein the content-element selector selects as the first content element one of the plurality of content elements which is to be displayed at the bottom section, and

wherein the data transformer produces the printed-image data, such that, provided that the second printed image is to be printed over the plurality of consecutive pages, the first printed image is printed redundantly over the sub-plurality of consecutive pages, at a footer section on each print sheet.

In a network environment, a desired content is displayed in the form of a web page on a display screen using displaying data presented from a network (e.g., a wide area network (e.g., the Internet) or a local area network). In a typical web page, there is also a highly likelihood that an advertising image is laid out on a web page at its bottom section.

Therefore, for example, it is preferable to define the displaying data as web page data, to define the pre-selected display location as the bottom section of the display area, and to define the first printed image as an advertising image.

With this in mind, in this information terminal equipment constructed according to the present mode, one of a plurality of content elements which is to be displayed at a bottom section on the content object is selected as the first content element.

Further, the printed-image data is produced when the second printed image is to be printed over a plurality of consecutive pages, such that the first printed image is printed redundantly over a sub-plurality of consecutive pages, at a footer section on each print sheet.

When practicing this information terminal equipment in an exemplary arrangement in which a web page is displayed on a display screen in a manner that an advertising image is laid out at a bottom section on the web page, the web page is printed, when needed, such that the advertising image appear redundantly over a plurality of pages over which other elements in the same web page (e.g., a text body) are to be printed.

Additionally, this information terminal equipment would allow the first content element, which is to say, one of content elements which is displayed at a bottom section on the content object, to be printed on each print page at its footer section.

In this regard, the bottom section on the content object and the footer section on each print page are comparable in terms of position

Therefore, this information terminal equipment would allow the first content element to be printed on pages based on the displaying data representative of the first content element, in a print layout without any major changes from the original display layout of the first content element.

(9) The information terminal equipment according to mode (8), wherein the server device is a web server storing a web page defining the content,

wherein the displaying data is constructed in a table allowing the plurality of content elements to be represented in association with respective display locations on the web page, to thereby describe the web page,

wherein the table includes information indicating that the first printed image is to be printed at the footer section, and

wherein the footer section is pre-selected positionally relative to each print sheet designated by a user.

(10) The information terminal equipment according to any one of modes (1)-(9), wherein the display location includes a section in which advertising information is to be displayed, and

wherein the first content element represents the advertising information.

This apparatus would allow an advertising image, at the time of printing out the whole content presented to a user from the server device via the network, to be printed redundantly over a plurality of separate sheets, resulting in enhanced advertising effect of the advertising image.

(11) The information terminal equipment according to any one of modes (1)-(10), wherein the display location includes a section in which reference information is to be displayed, the reference information being referenced by a user while viewing the second content element concurrently displayed on the display screen, for promoting the user to understand the second content element, and

wherein the first content element represents the reference information.

In this information terminal equipment, the displaying data may be used to define the display layout of a document (i.e., an example of the content) within a display screen. In this instance, the display layout may be standardized for allowing a reference helpful to a user in understanding the document to be displayed at the pre-selected display location.

With this in mind, this information terminal equipment may be practiced in combination with a server device configured to store and send the displaying data for allowing such a reference information to be displayed at the pre-selected display location.

In this instance, this information terminal equipment would cause a printer to print the reference information redundantly over a plurality of separate-sheets.

Therefore, this information terminal equipment would allow the reference information included in the displaying data, to be printed on every page based on the displaying data, resulting in enhanced effect of the reference information on a user in understanding a document concurrently printed on a page-by-page basis.

(12) The apparatus according to any one of modes (1)-(11), wherein the data transformer produces the printed-image data for allowing the first printed image to be printed redundantly over a plurality of consecutive separate pages, and for allowing the second printed image to be printed on the plurality of consecutive separate pages, on a page-by-page basis.

(13) The information terminal equipment according to any one of modes (1)-(12), wherein the first content element is one of the plurality of content elements which has a subsidiary meaning to a user requesting the content, and

wherein the second content element is one of the plurality of content elements which has a primary meaning to the user.

(14) An information terminal equipment communicable with a server device via a network,

wherein the server device is configured such that, in response to reception of a content request signal from the information terminal equipment via the network, the server device sends content data at least including displaying data for use in displaying on a display screen a content object requested by the content request signal, and

wherein the content data further includes printing data for use in printing the content object, the printing data indicating whether each of the plurality of content elements is a primary content element or a subsidiary content element,

the information terminal equipment comprising:

a communication unit that enables the information terminal equipment to communicate with the server device via the network; and

a data transformer operable when a primary printed image corresponding to the primary content element is to be printed over a plurality of consecutive pages, to transform the content data received from the server device, into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

When practicing this information terminal equipment, with the content data including not only the displaying data but also the printing data, the primary and subsidiary printed image are printed on pages at respective print locations defined by the printing data.

In this regard, the subsidiary printed image is printed redundantly over a plurality of pages, when the primary image is required to be printed over a plurality of pages.

Therefore, this information terminal equipment would allow the subsidiary printed image corresponding to the subsidiary content element to be printed in a print layout not depending on a display layout in which the subsidiary content element is displayed on a display screen, over a plurality of pages over which the primary printed image corresponding to the primary content element is printed.

As a result, when this information terminal equipment is practiced in an exemplary arrangement in which the subsidiary content element is defined as an advertising image; reference information useful to a user in understanding a document included in the primary content element; etc., and in which the printing data is defined as data representative of an advertising image or the like, the printed image corresponding to the advertising image or the like is printed in such a manner to easily catch a user's eye.

More specifically, when this information terminal equipment is practiced so as to define the subsidiary content element as an advertising image, the advertising image, at the time of printing out the whole content presented from the network, is printed over a plurality of pages, with enhanced advertising effect.

In addition, when this information terminal equipment is practiced so as to define the subsidiary content element as reference information, the document presented from the network is printed on pages based on the printing data, in a manner that allows a user to understand the document with enhanced ease.

When practicing this information terminal equipment, although the subsidiary printed image, which corresponds to the subsidiary content element may be printed over a sub-plurality of pages which are fewer than a plurality of pages over which the primary printed image is to be printed, the subsidiary printed image is preferably printed over a total of a plurality of pages over which the primary printed image is to be printed.

(15) The information terminal equipment according to mode (14), further comprising:

a content requesting unit that sends the content request signal to the server device;

a data reception unit that receives the content data incoming from the server device;

a display controller that causes a display unit to display the content, based on the displaying data received from the server device; and

a printer controller that causes a printer to print the primary and subsidiary printed-images over the sub-plurality of consecutive pages, based on the printed-image data produced by the data transformer.

(16) The information terminal equipment according to mode (14) or (15), wherein the data transformer produces the printed-image data, such that a print location at which the primary printed image is to be printed is assigned to a first print location which is pre-selected geometrically relative to each one of separate print-sheets on which the pages are to be printed, and such that a print location at which the subsidiary printed image is printed is assigned to a second print location which is pre-selected geometrically relative to each one of separate print-sheets on which the pages are to be printed.

(17) The information terminal equipment according to any one of modes (14)-(16), wherein the data transformer produces the printed-image data, such that print locations at which the primary and subsidiary printed-images are to be respectively printed on separate print-sheets do not depend on display locations at which the primary and subsidiary content elements are respectively displayed.

(18) The information terminal equipment according to any one of modes (14)-(17), wherein the data transformer produces the printed-image data, such that, provided that the primary printed image is to be printed over the plurality of consecutive pages, the subsidiary printed image is printed redundantly over a total of the same pages, at the pre-selected print location on each page.

This information terminal equipment would allow the subsidiary printed image corresponding to the subsidiary content element to be printed redundantly over a total of a plurality of pages over which the primary printed image corresponding to the primary content element is printed.

Therefore, this information terminal equipment would allow the subsidiary content element to catch a user's eye t more easily than when the same is printed redundantly over of a part of a plurality of pages over which the primary content element is printed.

Additionally, this information terminal equipment, when the subsidiary content element contains an advertising image or information, would avoid a user action of throwing away a part of the printed pages, if any, from lessening the advertising effect of the advertising image, because the subsidiary content element is printed redundantly over a total of a plurality of pages over which the primary content element is printed.

As a result, this information terminal equipment would allow the advertising effect of the advertising image to be enhanced.

(19) The information terminal equipment according to any one of modes (14)-(18), wherein the server device is a web server storing a web page defining the content object;

wherein the content data is constructed to include comment data not used in displaying the content on the display screen; and

wherein the comment data includes the printing data.

(20) A server device communicable with an information terminal equipment via a network, comprising:

a receiver that receives a content request signal from the information terminal equipment via the network; and

a transceiver that, in response to reception of the content request signal, sends content data at least including displaying data for use in displaying on a display screen a content object requested by the content request signal,

wherein the content data further includes printing data for use in printing the content object, the printing data indicating whether each of the plurality of content elements is a primary content element or a subsidiary content element, and

wherein the information terminal equipment is configured to include:

a communication unit that enables the information terminal equipment to communicate with the server device via the network; and

a data transformer operable when a primary printed image corresponding to the primary content element is to be printed over a plurality of consecutive pages, to transform the content data received from the server device into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

When practicing this server device with the content data including not only the displaying data but also the printing data, the information terminal equipment allows the primary and subsidiary printed image to be printed on pages at respective print locations defined by the printing data.

In this regard, the subsidiary printed image is printed redundantly over a plurality of pages, when the primary image is required to be printed over a plurality of pages.

Therefore, when this server device is practiced in combination with the information terminal equipment, the subsidiary printed image corresponding to the subsidiary content element is printed in a print layout not depending on a display layout in which the subsidiary content element is displayed on a display screen, over a plurality of pages over which the primary printed image corresponding to the primary content element is printed.

As a result, when this server device is practiced in an exemplary arrangement in which the subsidiary content element is defined as an advertising image; reference information useful to a user in understanding a document included in the primary content element; etc., and in which the printing data is defined as data representative of an advertising image or the like, the information terminal equipment allows the printed image corresponding to the advertising image or the like, to be printed in such a manner to easily catch a user's eye.

More specifically, when this server device is practiced so as to define the subsidiary content element as an advertising image, the advertising image, at the time of printing out the whole content presented from the network, is printed over a plurality of pages, with enhanced advertising effect.

In addition, when this server device is practiced so as to define the subsidiary content element as reference information, the document presented from the network is printed on pages based on the printing data, in a manner that allows a user to understand the document with enhanced ease.

(21) A method of operating an information terminal equipment communicable with a server device via a network,

wherein the server device is configured such that, in response to reception of a content request signal from the information terminal equipment via the network, the server device sends content data at least including displaying data for use in displaying on a display screen a content object requested by the content request signal,

the method comprising the steps of:

sending the content request signal to the server device;

receiving the content data from the server device, the content data including the displaying data;

selecting as a first content element one of a plurality of content elements represented by the displaying data, based on the displaying data received from the server device, wherein the first content element is to be displayed on the display screen at a pre-selected display location on the content object; and

when a second printed image corresponding to a second content element of the plurality of content elements which is other than the first content element is to be printed over a plurality of consecutive pages, transforming the received displaying data into printed-image data for allowing a first printed image corresponding to the first content element to be printed on separate print-sheets redundantly over a sub-plurality of consecutive pages equal to or fewer than the plurality of consecutive pages on which the second printed image is printed, at a pre-selected print location on each page.

When this method is implemented, a printed image corresponding to the displaying data is printed on consecutive separate sheets, in a manner that one of content elements (i.e., sets of information) which has a display location equal to a pre-selected display location (i.e., a specific display location) on a display screen catches a user's eye with enhanced ease.

(22) A program to be executed by a computer to implement the method according to mode (21).

The execution of this program provides the same function and effects as when the method according to the previous mode (21) is practiced.

The “program” in this mode may be interpreted to incorporate not only a combination of instructions implemented by a computer to perform the functions of the program, but also files, data, etc. processed depending on each of the instructions.

(23) A computer-readable storage medium which has stored therein the program according to mode (22).

The execution of the program which has been stored in this storage medium provides the same function and effects as when the method according to the previous mode (21) is practiced.

Throughout the description, the term “storage medium” may be interpreted to mean a magnetic recording medium such as a flexible-disc, an optical recording medium such as a CD and a CD-ROM, an optical-magnetic recording medium such as an MO, an un-removable storage such as a ROM, or otherwise a tangible medium for storage.

(24) A method of operating an information terminal equipment communicable with a server device via a network,

wherein the server device is configured such that, in response to reception of a content request signal from the information terminal equipment via the network, the server device sends content data at least including displaying data for use in displaying on a display screen a content object requested by the content request signal, and

wherein the content data further includes printing data for use in printing the content object, the printing data indicating whether each of the plurality of content elements is a primary content element or a subsidiary content element,

the method comprising the steps of:

sending the content request signal to the server device;

receiving the content data from the server device, the content data including the displaying data and the printing data; and

when a primary printed image corresponding to the primary content element is to be printed over a plurality of consecutive pages, transforming the received content data into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

When this method is implemented, the subsidiary printed image corresponding to the subsidiary content element is printed in a print layout not depending on a display layout in which the subsidiary content element is displayed on a display screen, over a plurality of pages over which the primary printed image corresponding to the primary content element is printed.

(25) A program to be executed by a computer to implement the method according to mode (24).

The execution of this program provides the same function and effects as when the method according to the previous mode (24) is practiced.

The “program” in the present mode may be interpreted to incorporate not only a combination of instructions implemented by a computer to perform the functions of the program, but also files, data, etc. processed depending on each of the instructions.

(26) A computer-readable storage medium which has stored therein the program according to mode (25).

The execution of the program which has been stored in this storage medium provides the same function and effects as when the method according to the previous mode (24) is practiced.

Several presently preferred embodiments of the invention will be described in more detail by reference to the drawings in which like numerals are used to indicate like elements throughout.

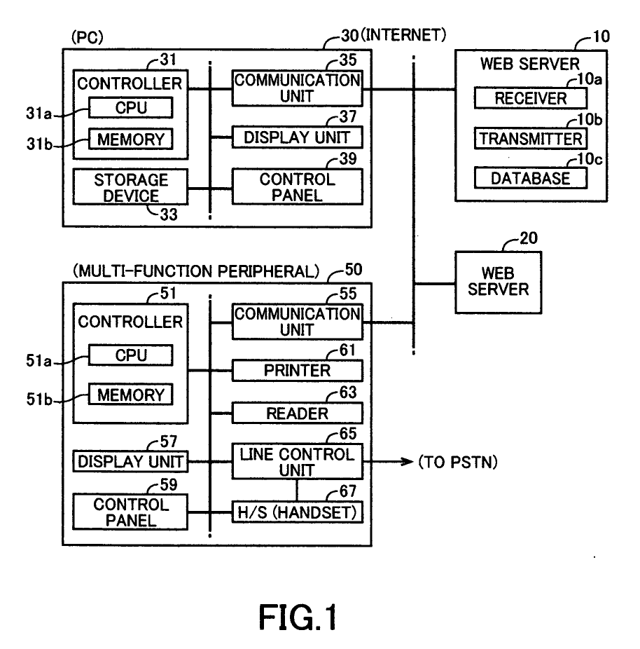

Referring now to FIG. 1, there is illustrated in block diagram a data presentation system 1 including an information terminal equipment constructed according to a first embodiment of the present invention.

The data presentation system 1 is configured to include web servers 10 and 20, an information terminal equipment in the form of a personal computer (hereinafter, referred to as “PC”) 30, and a digital multi-function peripheral (hereinafter, referred to as “multi-function peripheral”) 50. The web servers 10 and 20 are communicable with the PC 30 and the multi-function peripheral 50 over a wide area network in the form of the Internet.

Each web server 10, 20 is a server device for presenting various kinds of content objects to a requester device in the form of a web page (i.e., a document formatted according to Hypertext Mark-up Language (HTML)).

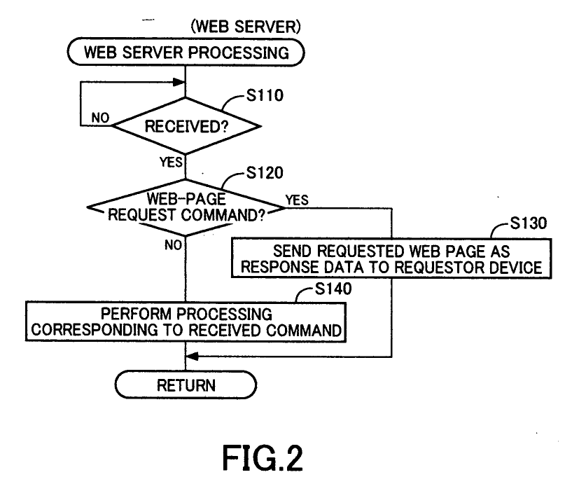

Each web server 10, 20, which is common in hardware construction with a conventional web server, has stored therein various web pages representative of various kinds of content objects. Each web server 10, 20 is configured to repeatedly implement web server processing illustrated in FIG. 2 in flow chart, to thereby, in response to a request from an external device in the form of a requestor device, present a requested one of the stored web pages to the requestor device.

More specifically, as illustrated in FIG. 1, each web server 10, 20 is configured to include a receiver 10a for receiving request signals from requester devices, a transmitter 10b for transmitting response signals to requestor devices, and a storage in the form of a database 10c. Each web server 10, 20 will be described below in greater detail with reference to FIG. 2.

The PC 30 is configured to include a controller 31 incorporating a Central Processing Unit (CPU) 31a performing various logical operations, and a memory 31b in the form of such as a Read Only Memory (ROM) and a Random Access Memory (RAM). The CPU 31a and the memory 31b together constitute a so-called computer.

The PC 30 further includes a storage device 33 in the form of a hard disk device for storing various application programs including a browser, and a communication unit 35 linked with the Internet so as to be communicable with devices in the Internet.

The PC 30 still further includes a display unit 37 in the form of such as a liquid crystal display, which displays information on a display screen, and a user-operable control panel 39 in the form of such as a keyboard and a pointing device (e.g., a mouse).

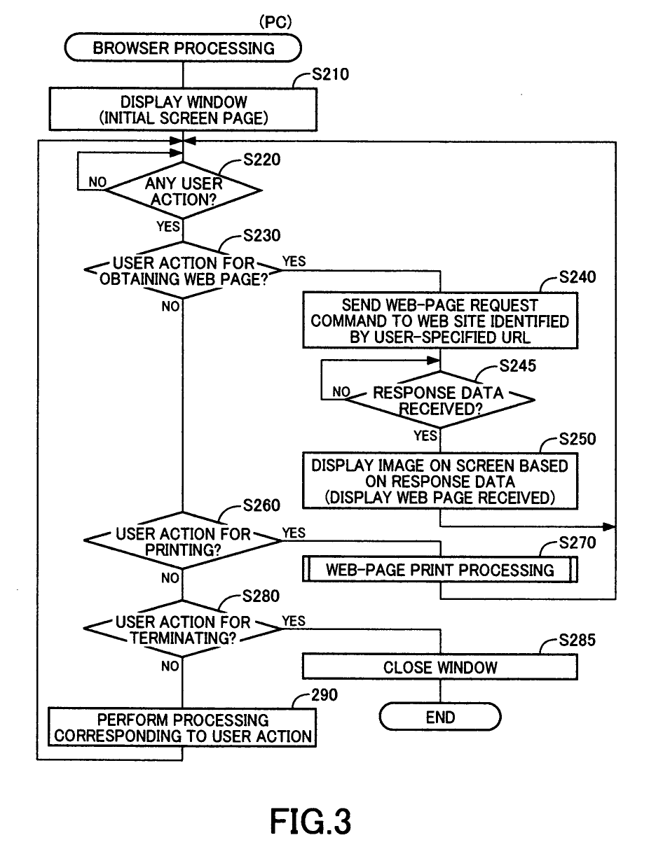

In operation, the PC 30, in response to a command issued from the control panel 39 by a user action for activating the browser, accesses the browser from the storage device 33, and activates the browser to thereby perform browser processing illustrated in FIG. 3.

The multi-function peripheral 50 is configured to include a controller 51 incorporating a Central Processing Unit (CPU) 51a performing various logical operations, and a memory 51b in the form of such as a Read Only Memory (ROM) and a Random Access Memory (RAM). The CPU 51a and the memory 51b together constitute a so-called computer.

The multi-function peripheral 50 further includes a communication unit 55 linked with the Internet so as to be communicable with devices in the Internet, a display unit 57 for displaying information on a display screen, and a user-operable control panel 59 comprised of various operational keys.

The multi-function peripheral 50 still further includes a printer 61; a reader (e.g., a scanner) 63; a line controller unit 65 coupled to a Public Switched Telephone Network (PSTN) so as to be communicable with external facsimile machines and telephone devices; and a handset (H/S) 67 comprised of a microphone and a speaker both for use in voice communication.

The multi-function peripheral 50 provides a printer function, a scanner function, a copy function, a facsimile function, and a telephone function, by causing the controller 51 to totally control the above-enumerated various components of the multi-function peripheral 50.

More specifically, the printer 61 operates under the control of the controller 51, to take a print sheet of paper in from a supply section (not shown) which is supporting a stack of print sheets, and then print an image on the print sheet in an ink-jet manner or a laser-print manner.

Upon reception of a print command through the communication unit 55 from, for example, the PC 30, the controller 51 starts controlling the printer 61 based on printed-image data (in the form of, e.g., Page Description Language (PDL) data), to thereby form on a print sheet a printed image represented by the printed-image data.

It is added that, when the controller 51 receives a plurality of pages' worth of printed-image data, the controller 51 causes the printer 61 to print the plurality of pages' worth of printed-image data on a consecutive pages in succession, in a manner well known in the art. This is due to the aforementioned printer function.

The reader 63 operates under the control of the controller 51, to optically read a document loaded into an auto document feeder (ADF) or a document supported on an original support table, to thereby produce image data representative of the document.

Upon entry of a read command from, for example, the PC 30, the controller 51 causes the reader 63 to optically read a document loaded into the ADF or a document supported on the original support table, and then temporarily stores the resulting image data in the memory 51b and/or sends the image data to the PC 30 which is a command issuer. This is due to the aforementioned scanner function.

On the other hand, upon entry of a copy command from the control panel 59, the controller 51 starts controlling the reader 63 to read an image deposited on a document loaded into the ADF or supported on the original support table, and in turn controlling the printer 61 to print the read image on print sheets. This is due to the aforementioned copy function.

The controller 51 accomplishes other functions including the facsimile function and the telephone function (e.g., a voice communication function) in a conventional procedure.

Next, there will be described web server processing performed by the web servers 10 and 20 constituting the data presentation system 1.

Referring now to FIG. 2, there is illustrated in flow chart the web server processing repeatedly performed by the web servers 10 and 20. The web servers 10 and 20 have stored therein a computer program executed for performing the web server processing. FIG. 2 is also a flow chart conceptually illustrating the computer program.

Upon commencement of one cycle of the web server processing illustrated in FIG. 2, the web servers 10 and 20 first wait until reception of any command from an external device such as the PC 30 or the multi-function peripheral 50 (step S110).

Upon reception of any command, the web servers 10 and 20 determine whether or not the received command is a web-page request command for requesting a certain web page (step S120).

If the web servers 10 and 20 determine that the received command is the web-page request command, then the web servers 10 and 20 access from the database 10c a web page identified by the web-page request command, and send the accessed web page as response data to a requestor device (step S130). Thereafter, the web servers 10 and 20 return to step S110.

It is added that, in the absence of the requested web page in the web server 10 or 20, the web servers 10 and 20 answer with an error message as response data.

If the web servers 10 and 20 receive a command other than a web-page request command, then the web servers 10 and 20 perform processing corresponding to the received command (step S140).

Thereafter, the web servers 10 and 20 return to step S110. The web servers 10 and 20 wait again until reception of a coming command from an external device (step S110).

Upon completion of step 130 or 140, one cycle of the web server processing is terminated.

Next, there will be described various sets of processing performed by the CPU 31a of the PC 30.

Referring now to FIG. 3, there is illustrated in flow chart the browser processing performed using the browser which has been stored in the storage device 33. The PC 30 has stored therein a computer program executed by the aforementioned computer for performing the browser processing. FIG. 3 is also a flow chart conceptually illustrating the computer program.

Upon commencement of the browser processing, the CPU 31a first displays on the display screen of the display unit 37 a new graphical-user-interface (GUI) window (i.e., a new GUI window) which is configured to additionally include indications such as icons for allowing a user action, and then displays an initial screen page within the current window (step S210).

Subsequently, the CPU 31a waits until a new user-action occurs on the current window (step S220). If a user action occurs on the current window, then the CPU 31a determines whether or not the current user action is a user action for obtaining a web page (step S230).

If so, then the CPU 31a sends a web-page request command for obtaining a desired web page identified by a Uniform Resource Locator (URL) specified by the current user action, to one of the web servers 10 and 20 which is identified by the user-specified URL, via the communication unit 35 (step S240). In this regard, the desired web page has been stored in the destination web-server 10 or 20.

Thereafter, the CPU 31a waits until the CPU 31a receives response data issued through the Internet and the communication unit 35 in reply to the sent request command (step S245).

If the CPU 31a receives the response data, then the CPU 31a updates the image displayed within the current window so as to reflect the received response data (step S250).

That is to say, the CPU 31a, once receiving a requested web page as response data from the web server 10 or 20, displays within the current window a content object represented by the received web page, in accordance with descriptions of the received web page which exclude descriptions associated with a “comment” tag (i.e., one of HTML tags). Each of the descriptions associated with a “comment” tag will be referred to as “comment data” which will be ignored by the browser.

If the CPU 31a receives an error message as response data, then the CPU 31a updates the image displayed so as to reflect the received error message.

Upon completion of step S250, the CPU 31a returns to step S220 to wait until a coming user action occurs.

If a user action is not for obtaining a web page, then the CPU 31a determines whether or not the user action is for printing (step S260). If so, then the CPU 31a proceeds to step S270 to perform web-page print processing.

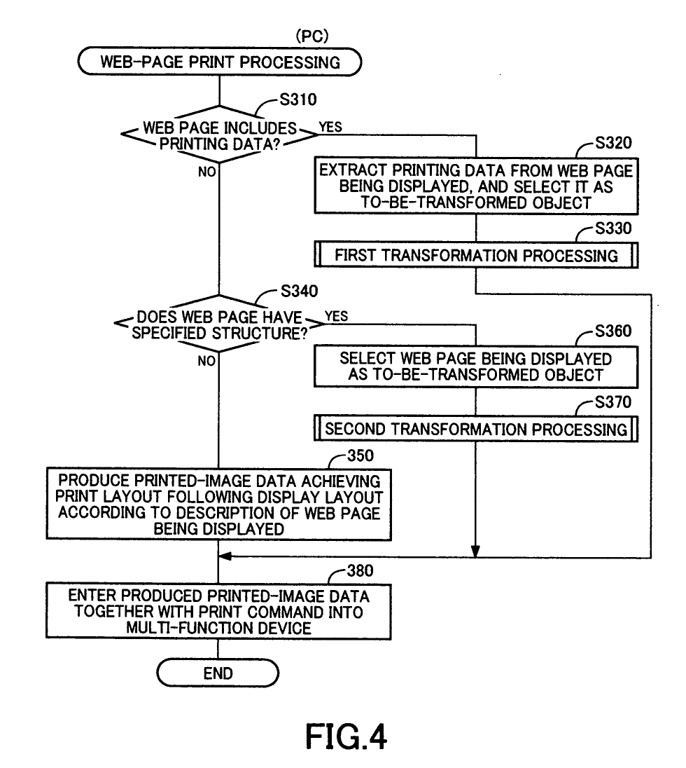

Referring then to FIG. 4, there is illustrated in flow chart the web-page print processing performed by the CPU 31a.

Upon commencement of this web-page print processing, the CPU 31a determines whether or not a currently displayed web page in the current window includes printing data (step S310).

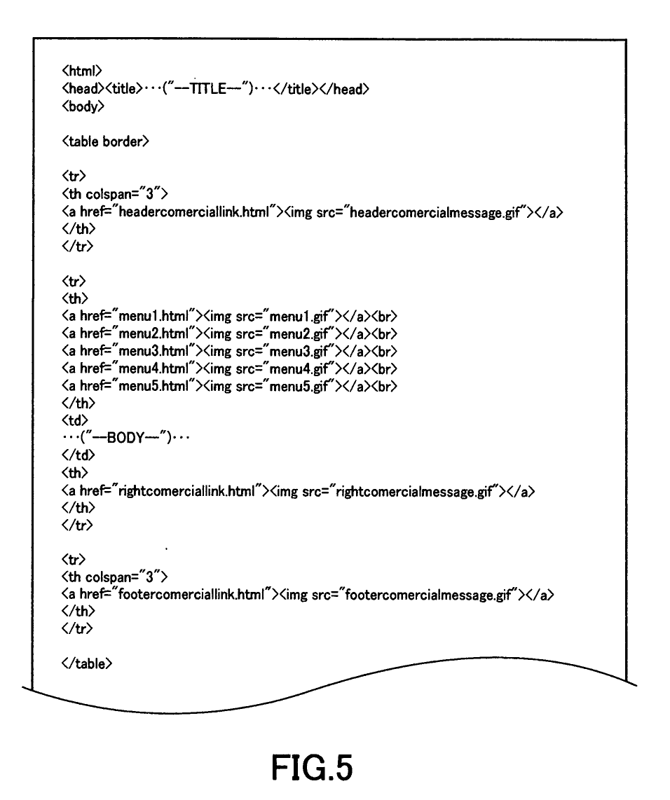

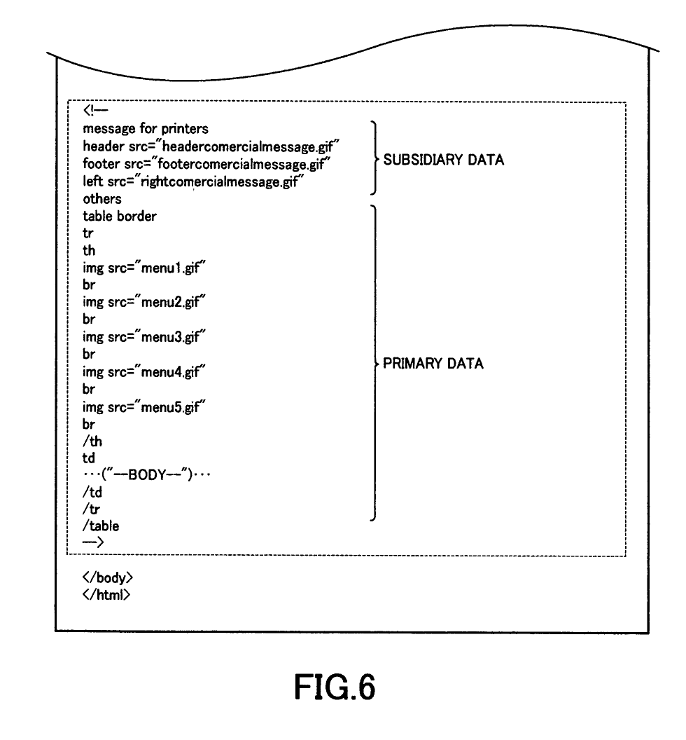

FIGS. 5 and 6 are views for illustrating an example of a source code of an exemplary web page including printing data. More specifically, FIG. 5 illustrates the first half of the source code, while FIG. 6 illustrates the second half of the same.

In the present embodiment, the web server 10 is adapted to store a web page including printing data as illustrated in FIGS. 5 and 6. As illustrated in FIG. 6, the web page includes printing data in the form of an invisible portion beginning with “message for printers”, which portion is illustrated within a dashed box in FIG. 6.

In addition to the printing data, the exemplary web page includes displaying data, which is in the form of a visible portion, and which is referred to by the browser for displaying the web page. In FIGS. 5 and 6, the displaying data is illustrated outside the dashed box illustrated in FIG. 6.

The invisible portion is provided for describing a comment in a web page. The comment is ignored by the browser, and is not referred to by the browser for displaying a web page. In a web page, a comment is inserted in a source code, with the comment in the form of a text being placed between comment tags denoted “<!--” and “-->”. For more details on HTML, the reader is directed to the Internet at “http://www.w3schools.com/html/”. This publication is incorporated herein by reference.

As will be evident from the above, in the present embodiment, the printing data illustrated in FIG. 6 in the dashed box is categorized as the aforementioned comment data.

Further, as illustrated in FIG. 6, in the present embodiment, the printing data is classified into primary data and subsidiary data.

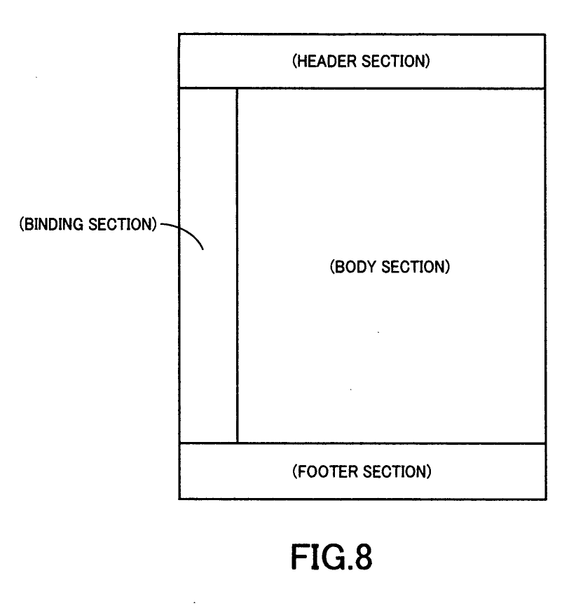

More specifically, as the primary data, the printing data includes data beginning with a character string “others” which describes an HTML document element which is to be printed in a body section of a print page (see FIG. 8). The HTML document element is a description without using the < > symbols.

Further, as the subsidiary data, the printing data also includes:

a file name of first image data (i.e., image data displayed on a web page) which is represented by the displaying data, and which is to be printed at a header section (see FIG. 8) of a print page;

a file name of second image data (i.e., image data displayed on a web page) which is represented by the displaying data, and which is to be printed at a footer section (see FIG. 8) of a print page; and

a file name of third image data (i.e., image data displayed on a web page) which is represented by the displaying data, and which is to be printed at a binding section or margin (see FIG. 8) of a print page.

These first, second and third image data are previously provided as portions (i.e., visible portions) of the displaying data, as illustrated in FIG. 5.

In other words, the printing data is constructed to include as the subsidiary data sets of data for identifying relationships between parameters and values for the following parameters:

parameter “header source” which has as a value a file name (in FIG. 6, “headercommercialmessage.gif”) of image data which is to be printed at a header section of a print page;

parameter “footer source” which has as a value a file name (in FIG. 6, “footercommercialmessage.gif”) of image data which is to be printed at a footer section of a print page; and

parameter “left source” which has as a value a file name (in FIG. 6, “rightcommercialmessage.gif”) of image data which is to be printed at a binding section of a print page.

As illustrated in FIG. 4, the CPU 31a first determines whether or not a currently displayed web page within the current window includes printing data (step S310). This determination is made by determining whether or not the web page includes comment data beginning with “message for printers”, in view of the result of a search for the comment data within the web page.

If so, then the CPU 31a extracts printing data from the current web page, and selects the extracted printing data as an object (hereinafter, referred to as “to-be-transformed object”) to be transformed into printed-image data (step S320).

Thereafter, the CPU 31a performs first transformation processing (step S330).

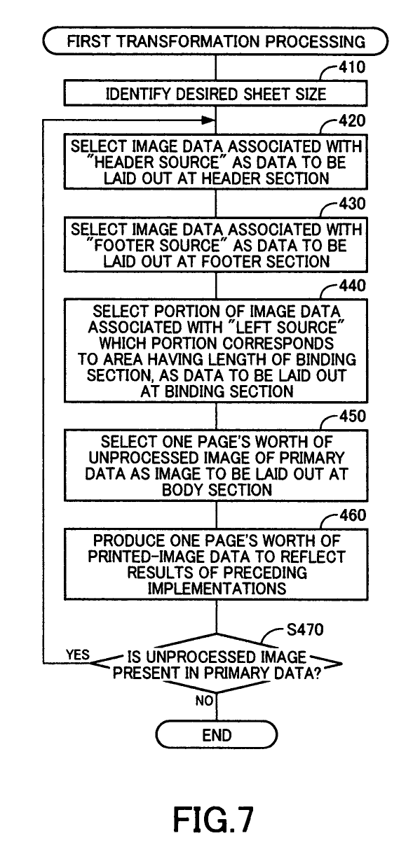

Referring then to FIG. 7, there is illustrated in flow chart the first transformation processing performed by the CPU 31a.

Upon commencement of this first transformation processing, the CPU 31a first identifies a desired size of print sheets on which a printed image is to be formed (step S410). The printed image corresponds to the printing data which has been selected as the to-be-transformed object. The desired sheet size is specified by a user when issuing a user action for printing. That is to say, at step S410, the CPU 31a identifies the user-specified sheet size.

Upon completion of step S410, the CPU 31a proceeds to step S420 to select from the printing data (i.e., the current to-be-transformed object) image data associated with parameter “header source”, as image data which will be laid out at a header section of a print sheet.

More specifically, at this step, the CPU 31a stores the image data associated with parameter “header source” as a printed object into a working area of the memory 31b, the CPU 31a imparts to the current image data, positional coordinates defining a header section on a print sheet, for assignment of a print location to the header section, and the CPU 31a performs other necessary operations, if any. As a result, the CPU 31a determines the print location of the current image data to be equal to a header section on a print sheet.

It is added that, in the present embodiment, as illustrated in FIG. 8, a header section is defined so as to have a length equal to the width of a rectangular printable region on a print sheet, to have a width of a predetermined value, and to have a starting point located at an upper-left end point of the rectangular printable region.

Upon completion of step S420, the CPU 31a proceeds to step S430 to select from the printing data (i.e., the current to-be-transformed object) image data associated with parameter “footer source”, as image data which will be laid out at a footer section on a print sheet.

More specifically, at this step, the CPU 31a stores the image data associated with parameter “footer source” as a printed object into the working area of the memory 31b, the CPU 31a imparts to the current image data, positional coordinates defining a footer section on a print sheet, for assignment of a print location to the footer section, and the CPU 31a performs other necessary operations, if any. As a result, the CPU 31a determines the print location of the current image data to be equal to a footer section on a print sheet.

It is added that, in the present embodiment, as illustrated in FIG. 8, a footer section is defined so as to have a length equal to the width of a rectangular printable region on a print sheet, to have a width of a predetermined value, and to have an ending point located at a lower-right end point of the rectangular printable region.

Upon completion of step S430, the CPU 31a proceeds to step S440 to select from the printing data (i.e., the current to-be-transformed object) image data associated with parameter “left source”, as image data which will be laid out at a binding section on a print sheet.

More specifically, at this step, the CPU 31a stores a portion of the image data associated with parameter “left source” as a to-be-printed object into the working area of the memory 31b. The portion of the image data is unprocessed data which has not yet been laid out on a print sheet, and represents a partial image having the same size as that of a binding section on a print sheet. The portion of the image data is referred to as “partial image data.”

Further, the CPU 31a imparts to the partial image data, positional coordinates defining a binding section on a print sheet, for assignment of a print location to the binding section, and the CPU 31a performs other necessary operations, if any.

As a result, the CPU 31a determines the print location of the current image data to be equal to a binding section on a print sheet.

It is added that, in the present embodiment, as illustrated in FIG. 8, a binding section is defined so as to have a location interposed between the header and footer sections, to have a width of a predetermined value, and to have a starting point located immediately below a lower-left end point of the header section having a rectangular shape.

Upon completion of step S440, the CPU 31a proceeds to step S450 to select from images represented by the primary data of the printing data (i.e., the current to-be-transformed object), one page's worth of unprocessed image, as an image which is to be laid out at a body section on a print sheet. The unprocessed image is what has not yet been transformed into printed-image data, in other words, what has not yet been laid out on a print sheet.

More specifically, at this step, the CPU 31a stores data corresponding to the one page's worth of unprocessed image into the working area of the memory 31b, the CPU 31a imparts to the current data, positional coordinates defining a body section of a print sheet, for assignment of a print location to the body section, and the CPU 31a performs other necessary operations, if any. As a result, the CPU 31a determines the print location of the current data to be equal to a body section on a print sheet.

It is added that, in the present embodiment, as illustrated in FIG. 8, a body section is defined to be equal to a portion of a printable region on a print sheet which is outside the header section, the footer section and the binding section.

Upon completion of step S450, the CPU 31a proceeds to step S460 to produce one page's worth of printed-image data (in the form of, for example, PDL data, raster image data, etc.) instructing that image data associated with parameter “header source” is laid out at a header section on a print sheet, image data associated with parameter “footer source” is laid out at a footer section on a print sheet, image data associated with parameter “left source” is laid out at a binding section on a print sheet, and one page's worth of unprocessed image extracted from the primary data is laid out at a body section on a print sheet, the production of printed-image data being performed so as to reflect the results obtained by implementing steps S420-450.

Upon completion of step S460, the CPU 31a proceeds to step S470 to determine whether or not there is present any unprocessed image (an image not yet laid out on a print sheet, or an image not yet transformed into printed-image data) in the primary data. If so, then the CPU 31a returns to step S420, and implements again steps S420-460 to produce new printed-image data for printing the next page.

More specifically, the CPU 31a produces one page's worth of printed-image data instructing that image data associated with parameter “header source” is laid out at a header section on a print sheet, that image data associated with parameter “footer source” is laid out at a footer section on a print sheet, that image data associated with parameter “left source” is laid out at a binding section on a print sheet, and that one page's worth of unprocessed image extracted from the primary data is laid out at a body section on a print sheet.

If the CPU 31a, after repeating steps S420-460, determines that there is no unprocessed image in the primary data, then the CPU 31a terminates one cycle of the implementation of the first transformation processing.

Upon completion of the first transformation processing at step S330 illustrated in FIG. 4 in a manner described above, the CPU 31a proceeds to step S380 to transfer a plurality of pages' worth of printed-image data produced ultimately, at a time, together with a print command, to the multi-function peripheral 50, to thereby cause the multi-function peripheral 50 to form printed image on print sheets based on the produced printed-image data.

More specifically, the CPU 31a causes the multi-function peripheral 50 to form a printed image corresponding to image data associated with parameter “header source”, at its header section of each print sheet on which a printed image corresponding to the primary data is printed.

The CPU 31a further causes the multi-function peripheral 50 to form a printed image corresponding to image data associated with parameter “footer source”, at its footer section of each print sheet on which the printed image corresponding to the primary data is printed.

The CPU 31a still further causes the multi-function peripheral 50 to form a printed image corresponding to image data associated with parameter “left source”, at its binding section of each print sheet on which the printed image corresponding to the primary data is printed.

If, however, the CPU 31a, at step S310 illustrated in FIG. 4, determines that a currently displayed web page within the current window includes no printing data, then the CPU 31a proceeds to step S340 to determine whether or not the current web page has a specified structure.

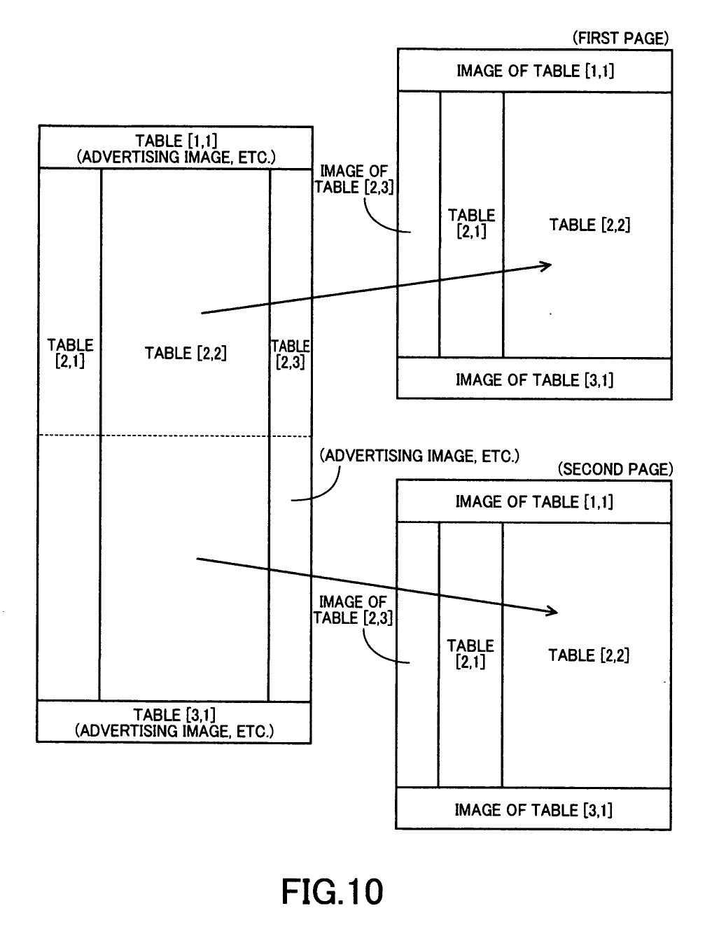

More specifically, the CPU 31a determines whether or not the current web page includes a body part formatted in a table of three rows and three columns (i.e., an example of the aforementioned specified structure) in which original cells at row 1 column 1 ([1, 1]) to row 1 column 3 ([1, 3]) are merged into a new cell in row 1 (denoted [1, 1] in FIG. 10), in which original cells at row 3 column 1 ([3, 1]) to row 3 column 3 ([3, 3]) are merged into a new cell in row 3 (denoted [3, 1] in FIG. 10), and sets of image data with respective links (hyperlinks) are laid out at the merged cell in row 1 ([1, 1]), the merged cell in row 3 ([3, 1]), and in which original cells at row 2 column 1 (denoted [2, 1] in FIG. 10), row 2 column 2 (denoted [2, 2] in FIG. 10), and row 2 column 3 (denoted [2, 3] in FIG. 10).

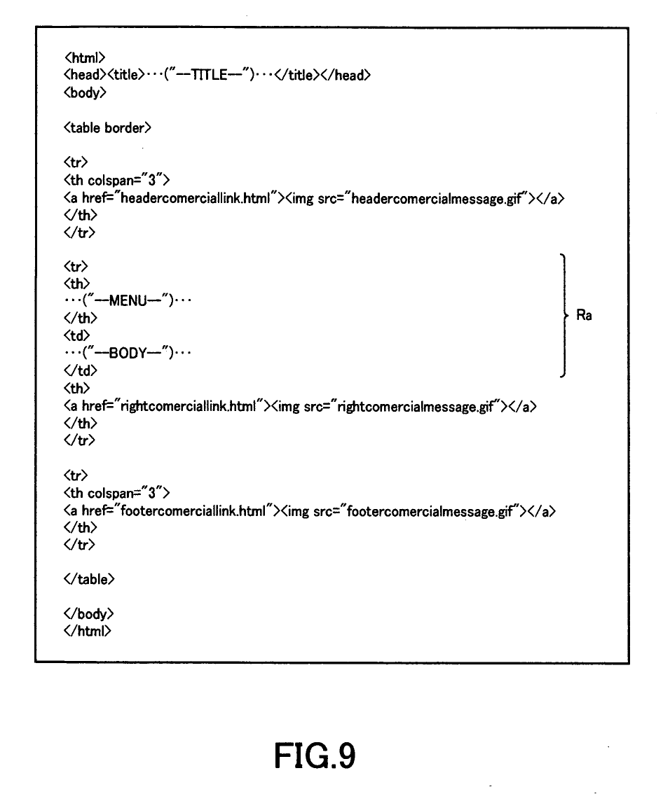

It is noted that FIG. 9 illustrates a source code of an exemplary web page having the specified structure (i.e., the table structure, in the present embodiment), and FIG. 10 illustrates how this web page is displayed on the display screen and how this web page is printed on two pages. In the present embodiment, the web server 20 is adapted to store such a type of web page.

If the CPU 31a, at step S340 illustrated in FIG. 4, determines that the current web page does not have the specified structure (i.e., the table structure), then the CPU 31a transforms data of a currently displayed web page within the current window, into printed-image data which allows the current web page to be printed on consecutive separate print pages in the same layout of the display layout of the current web page, on a page-by-page basis, so as to reflect the description (in HTML) of the current web page (step S350).

Upon completion of step S350, the CPU 31a proceeds to step S380 to transfer a plurality of pages' worth of printed-image data produced ultimately, at a time, together with a print command, to the multi-function peripheral 50, to thereby cause the multi-function peripheral 50 to form printed image on print sheets based on the produced printed-image data, on a page-by-page basis.

If, however, the CPU 31a determines that the currently displayed web page has the specified structure (i.e., the table structure), then the CPU 31a proceeds to step S360 to select the current displayed web page as a to-be-transformed object into printed-image data. Thereafter, at step S370, the CPU 31a performs second transformation processing.

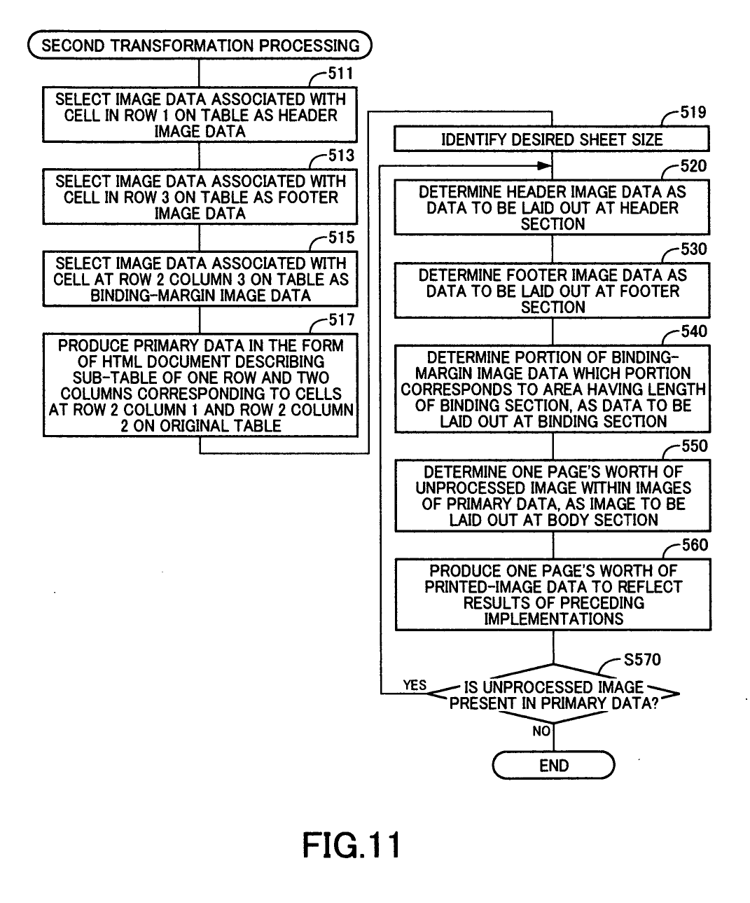

Referring now to FIG. 11, there is illustrated in flow chart the second transformation processing performed by the CPU 31a.

Upon commencement of this second transformation processing, the CPU 31a first performs data selection for the current web page (i.e., the to-be-transformed object).

More specifically, the CPU 31a first selects image data associated with the cell at row 1 ([1, 1]) of the table of FIG. 10 as header image data (step S511). The image data represents an advertising image and so on. Next, the CPU 31a selects image data associated with the cell at row 3 ([3, 1]) of the table of FIG. 10 as footer image data (step S513). The image data also represents an advertising image and so on.

Thereafter, the CPU 31a selects image data associated with the cell at row 2 column 3 ([2, 3]) of the table of FIG. 10 as binding-margin image data (step S515). The image data also represents an advertising image and so on.

Upon completion of step S515, the CPU 31a edits HTML document elements respectively associated with the cells at row 2 column 1 ([2, 1]) and row 2 column 2 ([2, 2]), to thereby produce primary data in the form of an HTML document element describing a sub-table of one row and two columns (step S517). In this regard, the sub-table corresponds to the cells at row 2 column 1 ([2, 1]) and row 2 column 2 ([2, 2]), and is placed within region Ra depicted in FIG. 9.

Describing more specifically the structure of the to-be-produced primary data with reference to FIG. 9, the primary data is an HTML document element in which the same written text as that in region Ra depicted in FIG. 9 concludes with a newly-added </tr> tag, and in which the combination of the written text and the </tr> tag is placed between a <table> tag and a </table> tag, both tags being called a pair of table tags.

Upon completion of step S517, the CPU 31a identifies a user-specified size of print sheets on which a printed image corresponding to the current web page (i.e., the to-be-transformed object) is to be printed (step S519). The user-specified sheet size is identified in the same manner as that at step S410 described above.

Upon completion of step S519, the CPU 31a proceeds to step S520 to determine the header image data selected at step S511, as image data which will be laid out at a header section of a print sheet.

More specifically, at this step, the CPU 31a stores the header image data as a printed object into the working area of the memory 31b, the CPU 31a imparts to the current image data, positional coordinates defining a header section on a print sheet, for assignment of a print location to the header section, and the CPU 31a performs other necessary operations, if any. As a result, the CPU 31a determines the print location of the current image data to be equal to a header section on a print sheet.

Upon completion of step S520, the CPU 31a proceeds to step S530 to determine the footer image data selected at step S513, as image data which will be laid out at a footer section on a print sheet.

More specifically, at this step, the CPU 31a stores the footer image data as a printed object into the working area of the memory 31b, the CPU 31a imparts to the current image data, positional coordinates defining a footer section on a print sheet, for assignment of a print location to the footer section, and the CPU 31a performs other necessary operations, if any. As a result, the CPU 31a determines the print location of the current image data to be equal to a footer section on a print sheet.

Upon completion of step S530, the CPU 31a proceeds to step S540 to determine the binding-margin image data selected at step S515, as image data which will be laid out at a binding section on a print sheet.

More specifically, at this step, the CPU 31a stores an unprocessed portion of the binding-margin image data as a printed object into the working area of the memory 31b. The unprocessed portion of the binding-margin image data is what has not yet been laid out on a print sheet, and represents a partial image having the same size as that of a binding section on a print sheet. The unprocessed portion of the binding-margin image data is referred to as “partial image data.”

Further, the CPU 31a imparts to the partial image data, positional coordinates defining a binding section on a print sheet, for assignment of a print location to the binding section, and the CPU 31a performs other necessary operations, if any.

As a result, the CPU 31a determines the print location of the current partial image data to be equal to a binding section on a print sheet.

Upon completion of step S540, the CPU 31a proceeds to step S550 to select from images represented by the primary data produced at step S517, one page's worth of unprocessed image, as an image which is to be laid out at a body section on a print sheet. The unprocessed image is what has not yet been laid out on a print sheet, in other words, what has not yet been transformed into printed-image data.

More specifically, at this step, the CPU 31a stores data corresponding to the one page's worth of unprocessed image into the working area of the memory 31b, and the CPU 31a imparts to the current data, positional coordinates defining a body section of a print sheet, for assignment of a print location to the body section. As a result, the CPU 31a determines the print location of the current data to be equal to a body section on a print sheet.

Upon completion of step S550, the CPU 31a proceeds to step S560 to produce one page's worth of printed-image data (in the form of, for example, PDL data, raster image data, etc.) instructing that header image data is laid out at a header section on a print sheet, the footer image data is laid out at a footer section on a print sheet, the binding-margin image data is laid out at a binding section on a print sheet, and one page's worth of image extracted from the primary data is laid out at a body section on a print sheet, the production of printed-image data being performed so as to reflect the results obtained by implementing steps S520-550.

Upon completion of step S560, the CPU 31a proceeds to step S570 to determine whether or not there is present any unprocessed image (an image not yet laid out on a print sheet, or an image not yet transformed into printed-image data) in the primary data. If so, then the CPU 31a returns to step S520, and implements again steps S520-560 to produce new printed-image data for printing the next page.

More specifically, the CPU 31a produces one page's worth of printed-image data instructing that the header image data is laid out at a header section on a print sheet, the footer image data is laid out at a footer section on a print sheet, the binding-margin image data is laid out at a binding section on a print sheet, and one page's worth of image extracted from the primary data is laid out at a body section on a print sheet.

If the CPU 31a, after repeating steps S520-560, determines that there is no unprocessed image in the primary data, then the CPU 31a terminates one cycle of the implementation of the second transformation processing.

Upon completion of the second transformation processing at step S370 illustrated in FIG. 4 in a manner described above, the CPU 31a proceeds to step S380 to transfer a plurality of pages' worth of printed-image data produced ultimately, at a time, together with a print command, to the multi-function peripheral 50, to thereby cause the multi-function peripheral 50 to form printed image on print sheets based on the produced printed-image data.

More specifically, the CPU 31a causes the multi-function peripheral 50 to form a printed image corresponding to image data which is displayed on a web page at its top section, at a header section of each print sheet on which a printed image corresponding to the primary data is printed.

The CPU 31a further causes the multi-function peripheral 50 to form a printed image corresponding to image data which is displayed on a web page at its bottom section, at a footer section of each print sheet on which the printed image corresponding to the primary data is printed.

The CPU 31a still further causes the multi-function peripheral 50 to form a printed image corresponding to image data which is displayed on a web page at its right-hand side section, at a binding section of each print sheet on which the printed image corresponding to the primary data is printed.

It is noted that a left-hand side of FIG. 10 illustrates a web page which is displayed on the display screen in the display layout, while a right-hand side of the same figure illustrates the same web page which is printed over two consecutive print sheets in the print layout, based on printed-image data into which content data of the same web page has been transformed.

Once the PC 30 in the present embodiment performs data processing for printing the web page illustrated in the left-hand side of FIG. 10, wherein the web page is constructed to include the primary data, and wherein a printed image corresponding to the primary data (Table [2, 1] and Table [2, 2]) is to be printed over a plurality of consecutive print pages, the print pages are ultimately printed as follows:

an image (including an advertisement) corresponding to the cell in row 1 (Table [1, 1]) of the table, in which the web page is structured, is printed on every print page at its header section;

an image (including an advertisement) corresponding to the cell in row 3 (Table [3, 1]) of the table, in which the web page is structured, is printed on every print page at its footer section; and

an image (including an advertisement) corresponding to the cell at row 2 column 3 (Table [2, 3]) of the table, in which the web page is structured, is printed on every print page at its binding section.

Upon completion of step S380 illustrated in FIG. 4, the CPU 31a terminates one cycle of the execution of the web-page print processing illustrated in FIG. 4, resulting in completion of step S270 illustrated in FIG. 3.

Upon completion of step S270, the CPU 31a proceeds to step S220 to wait until an occurrence of a new user-action.

If, however, a current user action is neither for obtaining a web page nor for printing, then the CPU 31a determines whether or not the current user action is for terminating (step S280). If so, then the CPU 31a proceeds to step S285 to close the current window for displaying of a web page. Then, the CPU 31a terminates one cycle of the execution of the browser processing.

If, however, the current user action to the current window is not for terminating, then the CPU 31a performs processing corresponding to the current user action (step S290).

Upon completion of step S290, then the CPU 31a proceeds to step S220 to wait until for an occurrence of a new user action.

The data presentation system 1, which has been described above, operates such that, if the CPU 31a of the PC 30, at step S340, determines, based on response data which the CPU 31a has received from the web server 10 or 20, that the CPU 31a has received a web page having the specified structure (i.e., the table structure), then the CPU 31a, at steps S511-515, analyses the received web page and selects the following sets of image, as elements of the web page corresponding to a printed image which is printed over a plurality of consecutive pages:

image data having its display location pre-selected at a top section (i.e., the cell in row 1 on the table) on the web page;

image data having its display location pre-selected at a bottom section (i.e., the cell in row 3 on the table) on the web page; and

image data having its display location pre-selected at a right-hand side section (i.e., the cell at row 2 column 3 on the table) on the web page.

Then, the CPU 31a, at step 560, produces printed-image data allowing printed images respectively corresponding to the sets of image data selected at steps S511-515, to be printed around the body section of each print page on which there is formed a printed image corresponding to the primary data (i.e., the remaining elements of the current web page), during transformation of the current web page into printed-image data.

More specifically, the CPU 31a, at step 560, when the printed-image corresponding to the primary data is to be printed over a plurality of print pages, produces printed-image data allowing printed images respectively corresponding to the sets of image data selected at steps S511-515, to be printed redundantly over a plurality of print pages, around the body section of each print page on which there is formed a printed image corresponding to the primary data.

Therefore, the data presentation system 1 would allow a printed image based on a web page to be formed on print sheets, in a manner that the following images easily catch a user's eye or visually attract a user's attention:

an image corresponding to image data having its display location pre-selected at a top section (i.e., the cell in row 1 on the table) on the web page;

an image corresponding to image data having its display location pre-selected at a bottom section (i.e., the cell in row 3 on the table) on the web page; and

an image corresponding to image data having its display location pre-selected at a right-hand side section (i.e., the cell at row 2 column 3 on the table) on the web page.

Describing more specifically, for a web page having the specified structure (i.e., the table structure), it is general that sets of data for advertisement are often laid out at the cell in row 1, the cell in row 2, and the cell at row 2 column 3 on the table structure. For such empirical knowledge, the data presentation system 1 would allow advertising images to be printed on every one of a plurality of consecutive pages, resulting in enhanced advertising effect of the advertising images.

If a web page is printed on a plurality of successive print pages in a print layout faithfully following a display layout of the web page on the display screen, then an advertising image laid out at the cell in row 1 on the table structure is printed only on a leading one of the successive print pages, and an advertising image laid out at the cell in row 3 on the table structure is printed only on a trailing one of the successive print pages. If a user throws away the leading and trailing pages, then none of those advertising images will catch the user's eye.

In contrast, the present embodiment would allow advertising images to be printed on every page. Therefore, even if the leading and trailing ones of the successive pages are thrown away, as long as the remaining ones are not thrown away, the advertising images can catch a user's eye, resulting in enhanced advertising effect of the advertising images.

The enhancement in the advertising effect makes it easier for a manager of a web server to profit from an advertiser in return for advertisement, contributing to successful management of the web server.

Further, the present embodiment would allow both a first image corresponding to image data having its display location on a web page at its top section and a second image corresponding to image data having its display location on the web page at its bottom section, to be printed on each print page, such that the first image is disposed at a header section on each print page and such that the second image is disposed at a footer section on each print page.

In this regard, the top section on the web page and the header section on the print page are comparable in terms of position, and similarly, the bottom section on the web page and the footer section on the print page are comparable in terms of position.

Therefore, the present embodiment would allow a printed image based on a web page to be formed on each print page, in a print layout or format that promotes advertising images to visually attract a user's attention, without any major changes from the original display layout or format of the web page.

The PC 30, when a received web page includes printing data describing to-be-displayed content elements such that the content elements are separated into primary data and subsidiary data, operates to select the printing data as the to-be-transformed object, and then to produce printed-image data corresponding to the web page, based on the printing data (step S330).

During the operation, the PC 30 produces the printed-image data so as to allow a printed image corresponding to the subsidiary data to be printed on each print sheet around an area in which a printed image corresponding to the primary data is printed on each print sheet.

Therefore, the PC 30, when the printed image corresponding to the primary data is to be printed over a plurality of print sheets, operates to produce the printed-image data so as to allow the printed image corresponding to the subsidiary data to be printed redundantly over a plurality of print sheets on which the printed image corresponding to the primary data is printed.

As will be evident from the above, owing to the thus-configured data presentation system 1 constructed according to the present embodiment, the PC 30, once receiving from the web server 10 or 20 a web page including printing data, operates to form the printed-image data corresponding to the subsidiary data, on print sheets over which the printed image corresponding to the primary data is to be printed, in a print layout without relying on the display layout of the web page.

Therefore, the data presentation system 1, provided that ones of the content elements of a web page which are desired to be printed redundantly over print sheets, such as advertising images or materials or references useful to a user in understanding a document presented by the web page, are previously selected as subsidiary data within the printing data, would allow printed images corresponding to such kinds of content elements to be formed on print sheets in a print layout promoting the printed images to visually attract a user's interest.

In other words, the present embodiment, provided that advertising images are previously selected as the subsidiary data within the printing data, would allow the advertising images to be printed over a plurality of print sheets when printing out a web page, resulting in enhanced advertising effect.

In addition, the present embodiment, provided that materials or references useful to a user in understanding a document presented by a web page are previously selected as the subsidiary data within the printing data, would allow the document to be printed on print sheets in a print layout promoting the user in understanding the document, when printing out the web page.

As will be readily understood from the above, in the present embodiment, the communication unit 35 constitutes an example of the “communication unit” set forth in the above mode (1), a portion of the PC 30 which is assigned to implement steps S511-515 of FIG. 11 constitutes an example of the “content-element selector” set forth in the same mode, and a portion of the PC 30 which is assigned to implement steps S520-570 of FIG. 11 constitutes an example of the “data transformer” set forth in the same mode.

Further, in the present embodiment, a portion of the PC 30 which is assigned to implement step S240 of FIG. 3 constitutes an example of the “content requesting unit” set forth in above mode (2), a portion of the PC 30 which is assigned to implement step S245 of FIG. 3 constitutes an example of the “data reception unit” set forth in the same mode, and a portion of the PC 30 which is assigned to implement step S380 of FIG. 4 constitutes an example of the “print controller” set forth in the same mode.

Still further, in the present embodiment, the communication unit 35 constitutes an example of the “communication unit” set forth in the above mode (14), and a portion of the PC 30 which is assigned to implement steps S420-470 of FIG. 7 constitutes an example of the “data transformer” set forth in the same mode.

Yet still further, in the present embodiment, a portion of the PC 30 which is assigned to implement step S240 of FIG. 3 constitutes an example of the “content requesting unit” set forth in above mode (15), a portion of the PC 30 which is assigned to implement step S245 of FIG. 3 constitutes an example of the “data reception unit” set forth in the same mode, and a portion of the PC 30 which is assigned to implement step S380 of FIG. 4 constitutes an example of the “print controller” set forth in the same mode.

Additionally, in the present embodiment, the receiver 10a and a portion of a computer of each web server 10, 20 which is assigned to implement step S110 of FIG. 2 together constitute an example of the “receiver” set forth in the above mode (20), and the transmitter 10b and a portion of the computer of each web server 10, 20 which is assigned to implement step S120-130 of FIG. 2 together constitute an example of the “transceiver” set forth in the same mode.

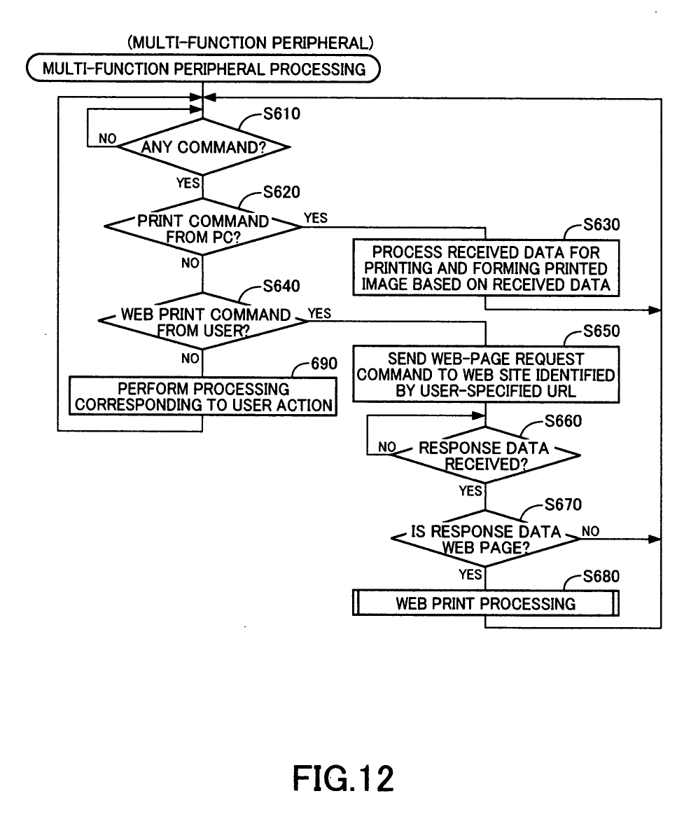

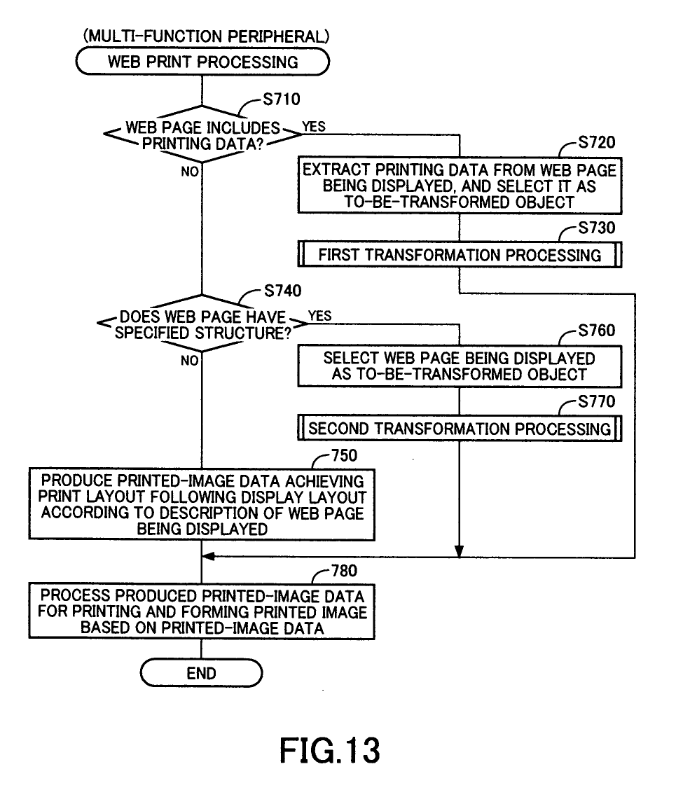

Next, a second embodiment of the present invention will be described with reference to FIGS. 12 and 13.

In the first embodiment described above, the PC 30 is configured to obtain a web page from the web server 10 or 20, and to produce printed-image data corresponding to the obtained web page, using the browser (and a printer driver installed in the PC 30 as an application program).

Alternatively, in the present embodiment, a multi-function peripheral 50 is configured to obtain a web page directly from the web server 10 or 20, to produce printed-image data corresponding to the obtained web page, in a manner similar with the manner in which the PC 30 produces printed-image data in the first embodiment, and then to form a printed image on print sheets, based on the produced printed-image data.

Now, there will be described a data presentation system 1 constructed according to the present embodiment which incorporates the thus-configured multi-function peripheral 50.

It is noted that this multi-function peripheral 50 will be described only with respect to the processing performed by the multi-function peripheral 50, in view of the fact that major modifications to the first embodiment lie in the processing performed by the multi-function peripheral 50 by executing a unique program described below.

Referring now to FIG. 12, there is described in flow chart multi-function peripheral processing performed repeatedly by the CPU 51a of the multi-function peripheral 50 within the data presentation system 1 constructed according to the present embodiment. The multi-function peripheral 50 has stored therein a computer program executed by the aforementioned computer for performing the multi-function peripheral processing. FIG. 12 is also a flow chart conceptually illustrating the computer program.

Upon commencement of the multi-function peripheral processing, the CPU 51a first waits until a command enters from an external device via the control panel 59 or the communication unit 55 (step S610). If a command enters, then the CPU 51a proceeds to step S620 to determine whether or not the entered command is a print command issued from the PC 30.

If so, then the CPU 51a processes printed-image data received from the PC 30 concurrently with the entry of the print command, in preparation for the coming printing, and causes the printer 61 to form a printed image based on the printed-image data, on print sheets, on a page-by-page basis (step S630). Upon completion of this step, the CPU 51a proceeds to step S610.

If, however, the entered command is not a print command issued from the PC 30, then the CPU 51a determines whether or not the entered command is a web print command which is issued by a user action to the control panel 59 (step S640).

If so, then the CPU 51a proceeds to step S650 to send a web-page request command for obtaining a desired web page identified by a Uniform Resource Locator (URL) specified by the current user action, to one of the web servers 10 and 20 which is identified by the user-specified URL, via the communication unit 55.

Thereafter, the CPU 51a waits until the CPU 51a receives response data issued through the Internet and the communication unit 55 in reply to the sent request command (step S660).

If the CPU 51a receives the response data, then the CPU 51a proceeds to step S670 to determine whether or not the received response data is a web page (i.e., an HTML document). If the CPU 51a determines that the received response data is not a web page but an error message, then the CPU 51a, after skipping step S680, proceeds to step S610 to wait until a next command enters.

If, however, the CPU 51a determines that the received response data is a web page, then the CPU 51a performs web print processing illustrated in FIG. 13, for printing the web page (step S680). FIG. 13 is a flow chart illustrating the web print processing performed by the CPU 51a of the multi-function peripheral 50. The multi-function peripheral 50 has stored therein a computer program executed by the aforementioned computer for performing the web print processing. FIG. 13 is also a flow chart conceptually illustrating the computer program.

Upon commencement of this web print processing, the CPU 51a first determines whether or not a received web page is a web page including printing data (step S710). If so, then the CPU 51a extracts the printing data from the current web page, and selects the extracted printing data as a to-be-transformed object into printed-image data (step S720).

Thereafter, at step S730, the CPU 51a performs first transformation processing. The first transformation processing is basically in common with that in the first embodiment. More specifically, in the first transformation processing in the present embodiment, steps (not shown) equivalent to steps S410-470 illustrated in FIG. 7 are implemented by the CPU 51a of the multi-function peripheral 50.

At step S730, the CPU 51a performs the first transformation processing, such that, using a working area assigned to the memory 51b of the multi-function peripheral 50, printed-image data is produced, and such that, at a step equivalent to step S410 of FIG. 7, the CPU 51a identifies a standard sheet size which is pre-selected for the multi-function peripheral 50.

The CPU 51a, once completing the first transformation processing at step S730 in a manner described above, processes the printed-image data resulting from the first transformation processing, in preparation for the coming printing, and causes the printer 61 to form a printed image based on the printed-image data on print sheets (step S780). Then, the CPU 51a terminates the web print processing.

If, however, the CPU 51a, at step S710, determines that the received web page is a web page not including printing data, then the CPU 51a proceeds to step S740 to determine whether or not the received web page has the specified structure (i.e., the table structure). The determination is made at this step in a manner similar with step S340 illustrated in FIG. 4.

If the CPU 51a, at step S740, determines that the current web page does not have the specified structure (i.e., the table structure), then the CPU 51a transforms the data of the received web page, into printed-image data which allows the current web page to be printed on consecutive separate print pages in the same layout of the display layout of the current web page, on a page-by-page basis, so as to reflect the description (in HTML) of the current web page (step S750).

Upon completion of this step, the CPU 51a proceeds to step S780 to process the produced printed-image data in preparation for the coming printing, and causes the printer 61 to form a printed image based on the printed-image data on print sheets. Then, the CPU 51a terminates the web print processing.

If, however, the CPU 51a, at step S740, determines that the received web page has the specified structure (i.e., the table structure), then the CPU 51a proceeds to step S760 to select the current web page as a to-be-transformed object into printed-image data.

Thereafter, at step S770, the CPU 51a performs second transformation processing. The second transformation processing is basically in common with that in the first embodiment. More specifically, in the second transformation processing in the present embodiment, steps (not shown) equivalent to steps S511-570 illustrated in FIG. 11 are implemented by the CPU 51a of the multi-function peripheral 50.

At step S770, the CPU 51a performs the second transformation processing, such that, using the working area assigned to the memory 51b of the multi-function peripheral 50, printed-image data is produced, and such that, at a step equivalent to step S519 of FIG. 11, the CPU 51a identifies a standard sheet size which is pre-selected for the multi-function peripheral 50.

The CPU 51a, once completing the second transformation processing at step S770 in a manner described above, processes the printed-image data resulting from the second transformation processing, in preparation for the coming printing, and causes the printer 61 to form a printed image based on the printed-image data on print sheets (step S780). Then, the CPU 51a terminates the web print processing.

The CPU 51a, once completing the web print processing at step S680 illustrated in FIG. 12, in a manner described above, proceeds to step S610 to wait until an entry of a new command.

If, however, the entered command is neither a print command nor a web print command, then the CPU 51a proceeds to step S690 to perform processing corresponding to the current command. Upon completion of this step, then the CPU 51a proceeds to step S610 to wait until for an entry of a new command.

The data presentation system 1 according to the present embodiment, which has been described above, would allow subsidiary information such as advertising images or references constituting elements of a web page, to be printed on each page around an area in which a printed image corresponding to the primary data is concurrently printed, similarly with the first embodiment.

Therefore, the present embodiment would allow a web page to be printed in a manner promoting the subsidiary information such as advertising images to visually attract a user's attention.

Conventionally, a web page including advertising images, while being viewed by a user, is printed over a succession of print pages, such that the advertising images are printed only on leading and trailing ones of the succession of print pages. This results in the likelihood that a user, under some circumstances, throws away ones of the printed pages appearing the advertising images, without viewing them carefully.

In contrast, in the present embodiment, the multi-function peripheral 50 operates to obtain a desired web page by a direct downloading from the web server 10 or 20, without displaying the web page on the display screen for a user viewing, and to then print the web page over a succession of print pages, such that the advertising images are printed redundantly (e.g., on every page) over the succession of print pages.

Therefore, the present embodiment would allow such advertisements to be printed with far enhanced advertising effect on a user, compared with a conventional advertising procedure in the art.

As will be readily understood from the above, in the present embodiment, the communication unit 55 constitutes an example of the “communication unit” set forth in the above mode (1).

Further, in the present embodiment, a portion of the multi-function peripheral 50 which is assigned to implement the steps equivalent to steps S511-515 of FIG. 11 constitutes an example of the “content-element selector” set forth in the above mode (1). The equivalent steps are included in step S770 of FIG. 13.

Still further, in the present embodiment, a portion of the multi-function peripheral 50 which is assigned to implement the steps equivalent to steps S520-570 of FIG. 11 constitutes an example of the “data transformer” set forth in the above mode (1). The equivalent steps are included in step S770 of FIG. 13.

Still yet further, in the present embodiment, a portion of the multi-function peripheral 50 which is assigned to implement step S650 of FIG. 12 constitutes an example of the “content requesting unit” set forth in above mode (2), a portion of the multi-function peripheral 50 which is assigned to implement step S660 of FIG. 12 constitutes an example of the “data reception unit” set forth in the same mode, and a portion of the multi-function peripheral 50 which is assigned to implement step S780 of FIG. 13 constitutes an example of the “print controller” set forth in the same mode.

Additionally, in the present embodiment, the communication unit 55 constitutes an example of the “communication unit” set forth in the above mode (14), and a portion of the multi-function peripheral 50 which is assigned to implement the steps equivalent to steps S420-470 of FIG. 7 constitutes an example of the “data transformer” set forth in the same mode. The equivalent steps are included in step S730 of FIG. 13.

Still additionally, in the present embodiment, a portion of the multi-function peripheral 50 which is assigned to implement step S650 of FIG. 12 constitutes an example of the “content requesting unit” set forth in above mode (15), a portion of the multi-function peripheral 50 which is assigned to implement step S660 of FIG. 12 constitutes an example of the “data reception unit” set forth in the same mode, and a portion of the multi-function peripheral 50 which is assigned to implement step S780 of FIG. 13 constitutes an example of the “printer controller” set forth in the same mode.

The present invention, although has been described above by way of the data presentation systems, the information terminal equipments and the computer programs each according to the preferred embodiments of the present invention, is not limited to those embodiments, and may be practiced in alternative embodiments.

In those previous embodiments, the system is configured to select even the image data associated with row 2 column 3 of the table illustrated in FIG. 10, as the subsidiary data to be printed redundantly over a plurality of print pages, and to form the printed image corresponding to the image data over a plurality of print pages.

However, the present invention may be practiced in an arrangement in which the image data associated with row 2 column 3 is selected as the primary data.

In addition, in those previous embodiments, the system is configured to accommodate a web page having the specified structure in the form of a table of three rows and three columns.

However, the present invention may be practiced to accommodate a web page having the specified structure in the form of a table of four or more rows, provided that image data associated with an uppermost row of the table is printed on each print page at its header section, and that image data associated with a lowermost row of the table is printed on each print page at its footer section, for example, in the procedure similar with that used for processing rows 1 and 3 of the table in those previous embodiments.

Moreover, in those previous embodiments, the system is configured such that, in the same sequence as that in which sets of image data respectively associated with “header source”, “footer source”, “left source”, and “primary data” appear in the comment data portion of the exemplary HTML document illustrated in FIG. 6 and are processed for data transformation, the print locations on each print page are assigned to the elements of the subsidiary data within the comment data portion, sequentially in the sequence in which a header section, a footer section, a binding section, and a body section on each print page are set forth herein.

However, the present invention may be practiced such that the print locations on each print page are assigned to the elements of the subsidiary data within the comment data portion, sequentially in the sequence specified by the description (in HTML) placed in the comment data portion.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An information terminal equipment communicable with a server device via a network,
wherein the server device is configured such that, in response to reception of a content request signal from the information terminal equipment via the network, the server device sends content data at least including displaying data for use in displaying on a display screen a content object requested by the content request signal,
the information terminal equipment comprising:
a communication unit that enables the information terminal equipment to communicate with the server device via the network;
a content-element selector that selects as a first content element one of a plurality of content elements represented by the displaying data, based on the displaying data received from the server device, wherein the first content element is to be displayed on the display screen at a pre-selected display location on the content object and
a data transformer operable when a second printed image corresponding to a second content element of the plurality of content elements which is other than the first content element is to be printed over a plurality of consecutive pages, to transform the received displaying data into printed-image data for allowing a first printed image corresponding to the first content element to be printed on separate print-sheets redundantly over a sub-plurality of consecutive pages equal to or fewer than the plurality of consecutive pages on which the second printed image is printed, at a pre-selected print location on each page.

2. The information terminal equipment according to claim 1, further comprising:
a content requesting unit that sends the content request signal to the server device;
a data reception unit that receives the content data incoming from the server device; and
a printer controller that causes a printer to print the first printed-image on separate print-sheets over the sub-plurality of consecutive pages, based on the printed-image data produced by the data transformer.

3. The information terminal equipment according to claim 1, wherein the displaying data is constructed to include:
the plurality of content elements to be displayed on the display screen; and
information for identifying display locations at which the plurality of content elements are to be respectively displayed on the display screen.

4. The information terminal equipment according to claim 1, wherein the data transformer produces the printed-image data, such that a print location at which the first printed image is to be printed is assigned to a first print location which is pre-selected geometrically relative to each page, and such that a print location at which the second printed image is printed is assigned to a second print location which is pre-selected geometrically relative to each page.

5. The information terminal equipment according to claim 1, wherein the data transformer produces the printed-image data, such that, provided that the second printed image is to be printed over the plurality of consecutive pages, the first printed image is printed redundantly over a total of the same pages, at the pre-selected print location on each page.

6. The information terminal equipment according to claim 1, wherein the display location on the display screen includes a top section on the content object,
wherein the content-element selector selects as the first content element one of the plurality of content elements which is to be displayed on the display screen at the top section, and
wherein the data transformer produces the printed-image data, such that, provided that the second printed image is to be printed over the plurality of consecutive pages, the first printed image is printed redundantly over the sub-plurality of consecutive pages, at a header section on each print sheet.

7. The information terminal equipment according to claim 6, wherein the server device is a web server storing a web page defining the content object,
wherein the displaying data is constructed in a table allowing the plurality of content elements to be represented in association with respective display locations on the web page, to thereby describe the web page,
wherein the table includes information indicating that the first printed image is to be printed at the header section, and
wherein the header section is pre-selected positionally relative to each print sheet designated by a user.

8. The information terminal equipment according to claim 1, wherein the display location on the display screen includes a bottom section on the content object,
wherein the content-element selector selects as the first content element one of the plurality of content elements which is to be displayed at the bottom section, and
wherein the data transformer produces the printed-image data, such that, provided that the second printed image is to be printed over the plurality of consecutive pages, the first printed image is printed redundantly over the sub-plurality of consecutive pages, at a footer section on each print sheet.

9. The information terminal equipment according to claim 8, wherein the server device is a web server storing a web page defining the content,
wherein the displaying data is constructed in a table allowing the plurality of content elements to be represented in association with respective display locations on the web page, to thereby describe the web page,
wherein the table includes information indicating that the first printed image is to be printed at the footer section, and
wherein the footer section is pre-selected positionally relative to each print sheet designated by a user.

10. The information terminal equipment according to claim 1, wherein the display location includes a section in which advertising information is to be displayed, and
wherein the first content element represents the advertising information.

11. The information terminal equipment according to claim 1, wherein the display location includes a section in which reference information is to be displayed, the reference information being referenced by a user while viewing the second content element concurrently displayed on the display screen, for promoting the user to understand the second content element, and
wherein the first content element represents the reference information.

12. The apparatus according to claim 1, wherein the data transformer produces the printed-image data for allowing the first printed image to be printed redundantly over a plurality of consecutive separate pages, and for allowing the second printed image to be printed on the plurality of consecutive separate pages, on a page-by-page basis.

13. An information terminal equipment communicable with a server device via a network,
wherein the server device is configured such that, in response to reception of a content request signal from the information terminal equipment via the network, the server device sends content data at least including displaying data for use in displaying on a display screen a content object requested by the content request signal, and
wherein the content data further includes printing data for use in printing the content object, the printing data indicating whether each of the plurality of content elements is a primary content element or a subsidiary content element,
the information terminal equipment comprising:
a communication unit that enables the information terminal equipment to communicate with the server device via the network; and
a data transformer operable when a primary printed image corresponding to the primary content element is to be printed over a plurality of consecutive pages, to transform the content data received from the server device, into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

14. The information terminal equipment according to claim 13, further comprising:
a content requesting unit that sends the content request signal to the server device;
a data reception unit that receives the content data incoming from the server device;
a display controller that causes a display unit to display the content, based on the displaying data received from the server device; and
a printer controller that causes a printer to print the primary and subsidiary printed-images over the sub-plurality of consecutive pages, based on the printed-image data produced by the data transformer.

15. The information terminal equipment according to claim 13, wherein the data transformer produces the printed-image data, such that a print location at which the primary printed image is to be printed is assigned to a first print location which is pre-selected geometrically relative to each one of separate print-sheets on which the pages are to be printed, and such that a print location at which the subsidiary printed image is printed is assigned to a second print location which is pre-selected geometrically relative to each one of separate print-sheets on which the pages are to be printed.

16. The information terminal equipment according to claim 13, wherein the data transformer produces the printed-image data, such that print locations at which the primary and subsidiary printed-images are to be respectively printed on separate print-sheets do not depend on display locations at which the primary and subsidiary content elements are respectively displayed.

17. The information terminal equipment according to claim 13, wherein the data transformer produces the printed-image data, such that, provided that the primary printed image is to be printed over the plurality of consecutive pages, the subsidiary printed image is printed redundantly over a total of the same pages, at the pre-selected print location on each page.

18. The information terminal equipment according to claim 13, wherein the server device is a web server storing a web page defining the content object;
wherein the content data is constructed to include comment data not used in displaying the content on the display screen; and
wherein the comment data includes the printing data.

19. A method of operating an information terminal equipment communicable with a server device via a network,
wherein the server device is configured such that, in response to reception of a content request signal from the information terminal equipment via the network, the server device sends content data at least including displaying data for use in displaying on a display screen a content object requested by the content request signal,
the method comprising the steps of:
sending the content request signal to the server device;
receiving the content data from the server device, the content data including the displaying data;
selecting as a first content element one of a plurality of content elements represented by the displaying data, based on the displaying data received from the server device, wherein the first content element is to be displayed on the display screen at a pre-selected display location on the content object; and
when a second printed image corresponding to a second content element of the plurality of content elements which is other than the first content element is to be printed over a plurality of consecutive pages, transforming the received displaying data into printed-image data for allowing a first printed image corresponding to the first content element to be printed on separate print-sheets redundantly over a sub-plurality of consecutive pages equal to or fewer than the plurality of consecutive pages on which the second printed image is printed, at a pre-selected print location on each page.

20. A computer readable medium having stored thereon a computer executable program which, when executed by a computer, implements the method set forth in claim 19.

21. A method of operating an information terminal equipment communicable with a server device via a network,
wherein the server device is configured such that, in response to reception of a content request signal from the information terminal equipment via the network, the server device sends content data at least including displaying data for use in displaying on a display screen a content object requested by the content request signal, and
wherein the content data further includes printing data for use in printing the content object, the printing data indicating whether each of the plurality of content elements is a primary content element or a subsidiary content element,
the method comprising the steps of:
sending the content request signal to the server device;
receiving the content data from the server device, the content data including the displaying data and the printing data; and
when a primary printed image corresponding to the primary content element is to be printed over a plurality of consecutive pages, transforming the received content data into printed-image data for allowing the primary and subsidiary content elements to be printed on separate print-sheets, such that a subsidiary printed image corresponding to the subsidiary content element is printed redundantly over a sub-plurality of consecutive pages equal to or fewer than the plurality of consecutive pages on which the primary printed-image is printed, at a pre-selected print location on each page.

22. A computer readable medium having stored thereon a computer executable program which, when executed by a computer, implements the method set forth in claim 21.
